(19) United States
(12) Patent Application Publication
(10) Pub. No.: US 2026/0112285 A1
(43) Pub. Date: Apr. 23, 2026

(54) SYSTEMS AND METHODS FOR ASSESSING A SOFTWARE DEVELOPER

(71) Applicant: Engineer.ai Corp, Salt Lake City, UT (US)

(72) Inventors: Sachin Dev Duggal, Salt Lake City, UT (US); Rohan Patel, London (GB); Ralph Bourdoukan, Luton (GB)

(73) Assignee: Engineer.ai Corp., Salt Lake City, UT (US)

(21) Appl. No.: 18/919,425

(22) Filed: Oct. 18, 2024

(51) Int. Cl. G09B 7/02; G06Q 50/20

(52) U.S. Cl. CPC G09B 7/02; G06Q 50/205

(57) ABSTRACT

Systems, methods, and a computer readable storage medium are disclosed for generating a fingerprint. The method includes receiving a source code and analyzing the received source code. The method further includes tokenizing the source code to generate a sequence of tokens, the tokenization is based on a predefined set of reserved keywords and operators specific to a programming language and a framework. The method also includes generating the fingerprint for the source code based on the tokenization.

### FIELD OF THE INVENTION

This disclosure relates to software automation, machine learning AI, and project management.

### BACKGROUND

Software engineering or software development is the process of writing computer-readable code that may be executable or may be converted into executable instructions by a compiler. Crafting professional software code is a specialized skill that is valued in the professional workplace. At the same time, software engineers or developers that plagiarize the code of others are not only dishonest but defraud companies or other clients by tricking them into thinking that the developed code is new and by tricking the company into overestimating the value of the coder themselves.

Detecting such plagiarism is a challenging task because developed codes can be modified by talented developers in crafty or otherwise sinister ways to trick someone evaluating the code into thinking it is new. For instance, a coder may change variable names, function names, change the order of functions, modify comments, or the like, to change the overall appearance of a code without changing the underlying structure or process that the code completes. There is a need in the art for a system that detects plagiarism or otherwise makes it easier to detect plagiarism from submitted code samples.

### SUMMARY

Disclosed are methods, systems, and computer readable storage mediums for detecting plagiarism. A method includes breaking a software code or portion of software code down into a sequence of operators and reserved keywords. The sequence of operators and reserved keywords may be compared to another sequence of operators and reserved keywords of another code. Matching subsequences of the two sequences of operators and reserved keywords are identified and tabulated. A likelihood of plagiarism is determined based on a number and length of matching subsequences of operators and reserved keywords.

### BRIEF DESCRIPTION OF THE DRAWINGS

FIG. 1 is a software building system illustrating the components that may be used in an embodiment of the disclosed subject matter.

FIG. 2 is a schematic illustrating an embodiment of the spec builder in accordance with a described implementation of the disclosed subject matter.

FIG. 3 is a schematic illustrating an embodiment of interactor in accordance with a described implementation of the disclosed subject matter.

FIG. 4 is a schematic illustrating an embodiment of the management components in accordance with a described implementation of the disclosed subject matter.

FIG. 5 is a schematic illustrating an embodiment of the expert evaluation system in accordance with a described implementation of the disclosed subject matter.

FIG. 6 is a schematic illustrating an embodiment of an assembly line and surfaces of the disclosed subject matter.

FIG. 7A is a schematic for an embodiment of a run engine of the disclosed subject matter.

FIG. 7B is a schematic for an embodiment of a building block that may be implemented in the disclosed subject matter.

FIG. 7C is a schematic for an embodiment of an adapter that may be implemented in the disclosed subject matter.

FIG. 8 is a schematic illustrating an embodiment of the run entities of the disclosed subject matter.

FIG. 9 is a schematic illustration of a system that may be used to detect plagiarism in submitted code samples.

FIG. 10 is a schematic illustration of a system assessing developers by detecting plagiarism in submitted test samples.

FIG. 11 is a schematic diagram of a plagiarism detection system in an embodiment of the disclosed subject matter.

FIG. 12 is an illustration of two snippets of typescript code along with their tokenized representations.

FIG. 13 is an illustration of two snippets of python code along with their tokenized representations.

FIG. 14 is a flow diagram for an embodiment of the disclosed subject matter for a process of generating a plagiarism likelihood score.

FIG. 15 is a flow diagram for an embodiment of the disclosed subject matter for a process of generating a fingerprint for the source code.

FIG. 16 is a flow diagram for another embodiment of the disclosed subject matter for a process of generating a plagiarism likelihood score.

FIG. 17 is a schematic illustrating the computing components that may be used to implement various features of embodiments described in the disclosed subject matter.

### DETAILED DESCRIPTION

The disclosed subject matter is a method, system, and computer-readable storage medium for detecting plagiarism in submitted code samples. The term “code sample,” as used herein, refers to computer-readable code in a computer programming language that is compilable into executable instructions that may be processed by a processor coupled to a memory. A developer may write code in a programming language, such as JavaScript, and compile the code into executable instructions that are executable by a computer system. Plagiarism may occur when the developer borrows or copies the substantive portions of another developer's code. Many forms of reuse are acceptable in the workplace. For instance, it may be acceptable for a company or the developer to borrow open-source code. It may also be acceptable for a developer to borrow the code of another developer within the same company, especially when the purpose of the original code is to be copied. However, plagiarism may be unacceptable when the company or other entity that hires the developer is unaware or disapproves of the plagiarism. For instance, a company will certainly disapprove of plagiarism that could result in an accusation of copyright infringement. A company may disapprove of plagiarism when it is passed off by the developer in order to enhance the perceived value of the developer or overestimate the value of the developer. For instance, the developer may plagiarize code in order to make it appear as though the developer has a high rate of output.

The disclosed subject matter compares submitted code sample from a developer to historically submitted code samples to determine if substantive portions of the submitted code sample were plagiarized or otherwise copied from historical samples. One issue with making such a comparison is that developers can easily make minor or unsubstantive modifications to a code to achieve the exact same or just about the same result. For instance, the developer may modify function names, variable names, class names, comments, spacing, order of operations, or the like, to a code and still achieve essentially the same result. Accordingly, merely looking at two code samples or doing an exact one-to-one comparison of two code samples may overlook the exact same result. For example, the developer may modify a code that has been altered in unsubstantive ways.

The disclosed subject matter addresses the above-named issues by processing code samples down to a sequence of operators and reserved keywords. Examples of reserved keywords in the JavaScript language include if, while, print, function, let, and the like. Examples of operators in JavaScript may include the plus sign operator, minus sign operator, multiplication sign operator, divide sign operator, the and operator, or operator, xor operator, parentheses, colons, semicolons, and the like. The disclosed Plagiarism Detection System may compare sequences of operators and keywords between code samples to determine if the code samples or portions of the code samples were likely copied from one another. In an exemplary embodiment, the disclosed subject matter may determine if any sequences in two sets of codes are identical past a certain threshold. For instance, a threshold may be fifteen operators or keywords. Accordingly, the disclosed Plagiarism Detection System may identify all sequences greater than fifteen operators and keywords that are identical between two samples of code. Minor modifications such as comments, function names, and variable names are discarded, while the more substantive portions of the code sample are analyzed. Further, the disclosed Plagiarism Detection System distills code sample down to a relatively small sequence that can be easily or quickly processed to determine if code sequences are identical or partially identical. The specific list of operators and keywords may change between programming languages and even change based on the needs of a specific project. For instance, the parentheses operator may be discarded in certain instances where including it does not enhance or help the process. In an example embodiment, the list of operators and keywords that are extracted from a code are stored in a JSON or JSX file that is analyzed by the Plagiarism Detection System as part of every check of a code sample.

In an exemplary embodiment, the disclosed Plagiarism Detection System is used as part of an assessment for potential developers at a company or other similar entity. In an example of use, a company may provide a developer with an assignment or a generated assignment for which the developer will be asked to complete and be graded. It could be tempting for a developer who is tasked to complete such an assignment to plagiarize the assignment. A developer that does especially well on such assessments may be hired. Or, in some instances, even where a developer is hired, the developer's rank or intercompany standing may be elevated or lowered based on their performance in the assignment. Accordingly, the company or other entity that is administering the coding test has an incentive to not only grade the test, but also to verify the originality of the submitted code.

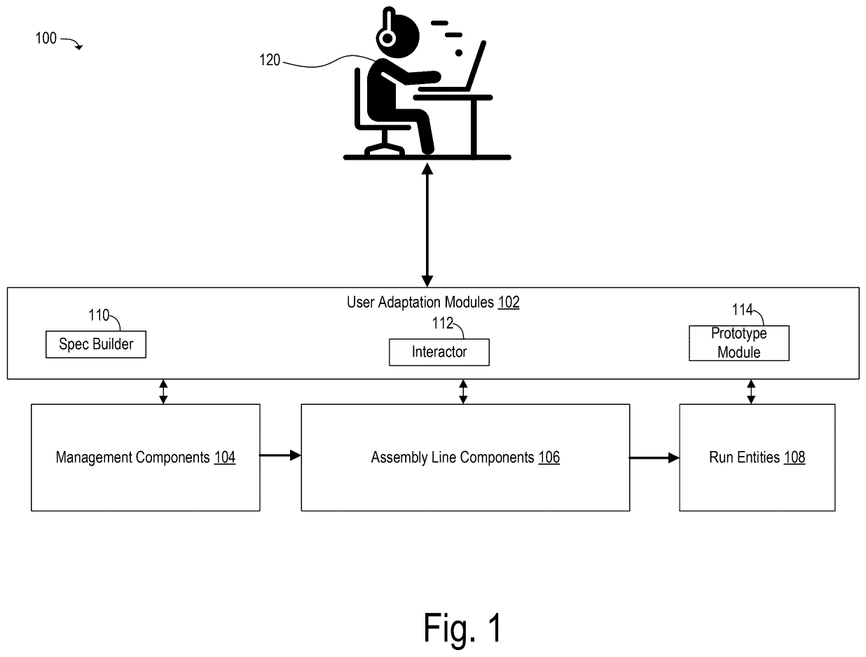

Referring to FIG. 1, FIG. 1 is a schematic of a software building system 100 illustrating the components that may be used in an embodiment of the disclosed subject matter. The software building system 100 is an AI-assisted platform that comprises entities, circuits, modules, and components that enable the use of state-of-the-art algorithms to support producing custom software.

A user 120 may leverage the various components of the software building system 100 to quickly design and complete a software project. The features of the software building system 100 operate AI algorithms where applicable to streamline the process of building software. Designing, building, and managing a software project may all be automated by the AI algorithms.

To begin a software project, an intelligent AI conversational assistant may guide users in the conception and design of their idea. Components of the software building system 100 may accept plain language specifications from a user 120 and convert them into a computer-readable specification that can be implemented by other parts of the software building system 100. Various other entities, modules, and components of the software building system 100 may accept the computer-readable specification or build card to automatically implement the computer-readable specification and/or manage the implementation of the computer-readable specification.

The embodiment of the software building system 100 shown in FIG. 1 includes user adaptation modules 102, management components 104, assembly line components 106, and run entities 108. The user adaptation modules 102 guide a user during all parts of a project from the idea conception to full implementation. User adaptation modules 102 may intelligently link a user to various entities of the software building system 100 based on the specific needs of the user.

The user adaptation modules 102 may include spec builder 110, an interactor 112 system, and the prototype module 114. They may be used to guide a user through the process of building software and managing a software project. Spec builder 110, the interactor 112 system, and the prototype module 114 may be used concurrently and/or linked to one another. For instance, spec builder 110 may accept user specifications that are generated in an interactor 112 system.

The prototype module 114 may utilize computer-generated specifications that are produced in spec builder 110 to create a prototype for various features. Further, the interactor 112 system may aid a user in implementing all features in spec builder 110 and the prototype module 114. The prototype module 114 may use a machine learning algorithm to select a most likely starting screen for each prototype. Thus, a user may select one or more features, and the prototype module 114 may automatically display a prototype of the selected features.

The prototype module 114 can automatically create an interactive prototype for features selected by a user. For instance, a user may select one or more features and view a prototype of one or more features before developing them. The prototype module 114 may determine feature links to which the user's selection of one or more features would be connected. In various embodiments, a machine learning algorithm may be employed to determine the feature links. The machine learning algorithm may further predict embeddings that may be placed in the user-selected features.

An example of the machine learning algorithm may be a gradient boosting model. A gradient boosting model may use successive decision trees to determine feature links. Each decision tree is a machine learning algorithm in itself and includes nodes that are connected via branches that branch based on a condition into two nodes. Input begins at one of the nodes whereby the decision tree propagates the input down a multitude of branches until it reaches an output node. The gradient boosted tree uses multiple decision trees in a series. Each successive tree is trained based on errors of the previous tree and the decision trees are weighted to return best results.

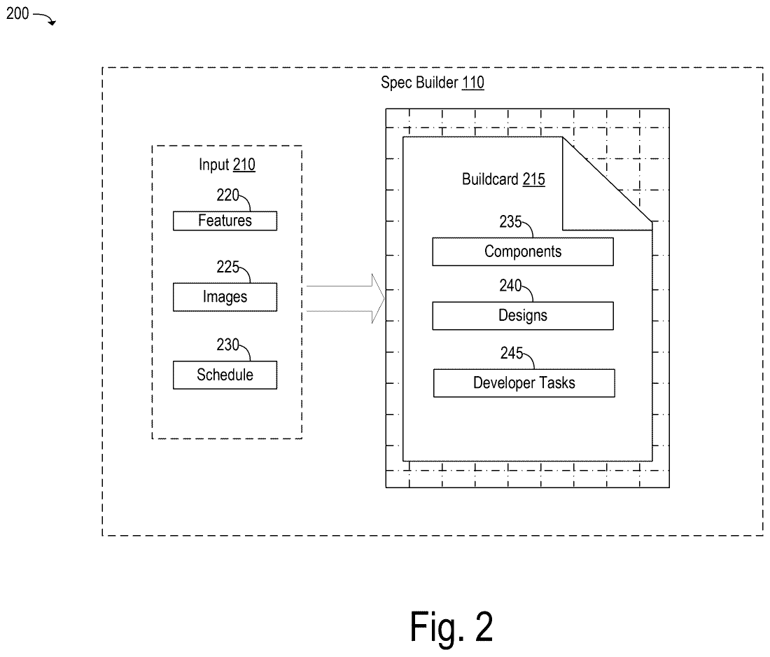

Referring to FIG. 2, FIG. 2 is a schematic 200 illustrating an embodiment of the spec builder 110 in accordance with a described implementation of the disclosed subject matter. Spec builder 110 converts input 210, such as user-supplied specifications, into specifications that can be automatically read and implemented by various objects, instances, or entities of the software building system 100. The machine-readable specification may be referred to herein as a buildcard 215. In an example of use, spec builder 110 may accept a set of features, platforms, etc., as input 210 and generate a machine-readable specification for that project.

Spec builder 110 may further use one or more machine learning algorithms to determine a cost and/or timeline for a given set of features. In an example of use, specification builder 110 may determine potential conflict points and factors that will significantly affect the cost and timeliness of a project based on training data. For example, historical data may show that a combination of various building block components creates a data transfer bottleneck. Spec builder 110 may be configured to flag such issues.

In an exemplary embodiment, a user may provide input 210, such as a plurality of features 220 to the spec builder 110. The spec builder 110 uses the features 220 to determine various components and designs 240 for a software application. For example, a user may provide that a software application should have a login feature. The spec builder 110 may determine that the login feature requires multiple components 235 and one or more designs 240 to implement the login feature.

The components 235 may comprise various functions, modules, classes, libraries, drivers, or the like that are used to code a software application. In various embodiments, the components 235 may comprise building block components as described below. The spec builder 110 may further generate one or more developer tasks 245 that would need to be completed to implement the login feature.

For example, one or more of the components 235 that were determined by the spec builder 110 may need to be custom built by a developer. One or more tasks will be generated by the spec builder to complete the one or more components 235 that need to be custom built. Each of these developer tasks 245 may be generated such that a skilled developer can read the developer task and follow it to build the component 235.

In various embodiments, each developer task may be written in such a way that an automated system may read the developer task 245 to develop the component 235 or design 240 for the software application. For example, the buildcard 215 may comprise a machine-readable specification and can be used as input for an automated system that generates components, designs, user interfaces, or the like for a software application based on the buildcard 215.

Likewise, the spec builder 110 may determine that one or more designs 240 should be implemented to complete the login feature. A design may comprise an organization of elements that are displayed on a screen for an end user. An end user, as described herein, may be an individual who is intended to use the completed software application. For example, a design for a login may comprise various screen elements that prompt an end user to enter a username and a password. The design 240 may specify any changes to a display as a software application is used. In the login feature example, the design 240 may determine what happens to a screen after an end user enters the username and password.

In various embodiments, a user may provide various images 225 to the spec builder 110. Spec builder 110 may leverage the images 225 to generate the designs 240. In an exemplary embodiment, a user may provide a sketch of various screens representing the user's vision of an operating software application. The spec builder 110 may generate designs 240 that approximate the user provided sketches.

In various embodiments, a user may provide a timeline or schedule 230 to the spec builder 110. The spec builder may use the schedule 230 to generate the developer tasks 245. In various embodiments, the spec builder 110 may split developer tasks 245 to accommodate a schedule 230. For example, a developer task that would normally be allocated to two developers, may be instead split among six developers to accommodate an aggressive schedule to develop a software application more quickly.

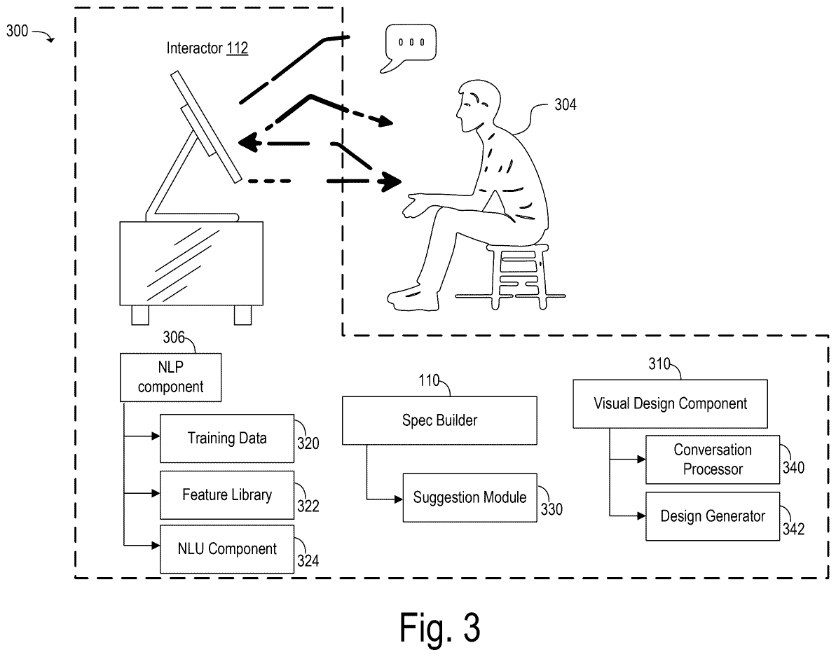

Referring to FIG. 3, FIG. 3 is a schematic 300 illustrating an embodiment of interactor 112 in accordance with a described implementation of the disclosed subject matter. The interactor 112 system is an AI powered speech and conversational analysis system. It converses with a user 304 with a goal of aiding the user 304. In one example, the interactor 112 system may ask the user 304 a question to prompt the user to answer about a relevant topic. For instance, the relevant topic may relate to a structure and/or scale of a software project the user wishes to produce. The interactor 112 system makes use of natural language processing (NLP) to decipher various forms of speech including comprehending words, phrases, and clusters of phases

In an exemplary embodiment, an NLP component 306 implemented by interactor 112 is based on a deep learning algorithm. Deep learning is a form of a neural network where nodes are organized into layers. A neural network has a layer of input nodes that accept input data where each of the input nodes are linked to nodes in a next layer. The next layer of nodes after the input layer may be an output layer or a hidden layer. The neural network may have any number of hidden layers that are organized in between the input layer and output layers.

Data propagates through a neural network beginning at a node in the input layer and traversing through synapses to nodes in each of the hidden layers and finally to an output layer. Each synapse passes the data through an activation function such as, but not limited to, a Sigmoid function. Further, each synapse has a weight that is determined by training the neural network. A common method of training a neural network is backpropagation.

Backpropagation is an algorithm used in neural networks to train models by adjusting the weights of the network to minimize the difference between predicted and actual outputs. During training, backpropagation works by propagating the error back through the network, layer by layer, and updating the weights in the opposite direction of the gradient of the loss function. By repeating this process over many iterations, the network gradually learns to produce more accurate outputs for a given input.

Various systems and entities of the software building system 100 may be based on a variation of a neural network or similar machine learning algorithm. For instance, input for NLP systems may be the words that are spoken in a sentence. In one example, each word may be assigned to separate input node where the node is selected based on the word order of the sentence. The words may be assigned various numerical values to represent word meaning whereby the numerical values propagate through the layers of the neural network.

The NLP component 306 employed by the interactor 112 system may output the meaning of words and phrases that are communicated by the user 304. The interactor 112 system may then use the NLP component 306 output to comprehend conversational phrases and sentences to determine the relevant information related to the user's goals of a software project. Further machine learning algorithms may be employed to determine what kind of project the user 304 wants to build including the goals of the user 304 as well as providing relevant options for the user 304.

In various embodiments, the neural network that comprises the NLP component 306 is trained with training data 320 based on previous software application projects. An example, the NLP component 306 is trained to identify features for software applications based on a description of the feature that is given by user 304. For example, a user may describe a communication system for a company where a computer receives communications from employee devices and transmits the communications appropriately to other employee devices where the communications are kept within the company. The NLP component 306 may identify the described functionality as a backend private messaging feature for a software application.

In various embodiments, the NLP component 306 has access to a feature library 322 that includes a multitude of completed components for software applications. The feature library may allow the software building system 100 to quickly include already-completed components in a software application without the need to write them from scratch. The NLP component 306 may be trained to identify components or designs from a feature library and suggest them to the user 304.

The NLP component 306 may include a natural language understanding (NLU) component 324. The NLU component 324 may allow the NLP component 306 to scan various documents and understand them. In one implementation, a user 304 may ask interactor 112 scan a multitude of documents as part of a description for what a software application will do.

In various embodiments, interactor 112 is coupled with spec builder 110 to generate machine-readable specifications or buildcards to develop software applications. In various embodiments, a user 304 may describe various features of a software application to interactor 112 and cause the spec builder 110 to generate a build card. The software building system 100 may determine a cost for the software developer project based on the build card and communicated to the user 304 via interactor 112. Interactor 112 may include a suggestion module 330 that suggests various modifications to the buildcard. In one implementation, the suggestion module 330 makes suggestions based on training data 320 from similar software development projects that have been completed.

In an exemplary embodiment, interactor 112 includes a visual design component 310. The visual design component 310 may be configured to generate one or more visual designs based on conversations that are recorded between interactor 112 and the user 304. The visual design component 310 may include a conversation processor 340 that logs a back-and-forth communication between the user 304 and interactor 112. The visual design component 310 may include a design generator 342 that determines one or more designs based on the log to conversation. In an exemplary embodiment, the design generator 342 generates designs based on training data 320 of conversations and designs from past software developed projects.

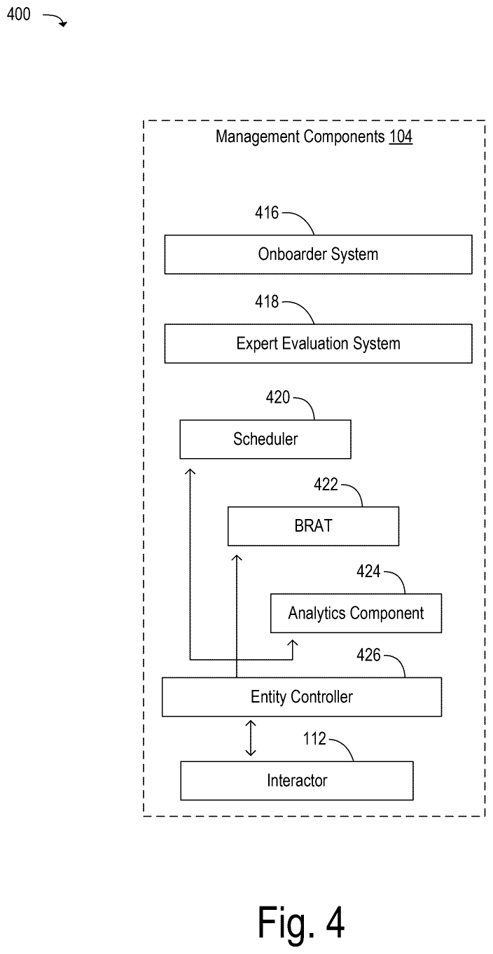

Referring to FIG. 4, FIG. 4 is a schematic 400 illustrating an embodiment of the management components 104 in accordance with a described implementation of the disclosed subject matter. The software building system 100 includes management components 104 that aid the user in managing a complex software building project. The management components 104 allow a user that does not have experience in managing software projects to effectively manage multiple experts in various fields. An embodiment of the management components 104 include the onboarding system 416, an expert evaluation system 418, scheduler 420, BRAT 422, analytics component 424, entity controller 426, and the interactor 112 system.

The onboarding system 416 aggregates experts so they can be utilized to execute specifications that are set up in the software building system 100. In an exemplary embodiment, software development experts may register into the onboarding system 416 which will organize experts according to their skills, experience, and past performance. In one example, the onboarding system 416 provides the following features: partner onboarding, expert onboarding, reviewer assessments, expert availability management, and expert task allocation.

An example of partner onboarding may be pairing a user with one or more partners in a project. The onboarding system 416 may prompt potential partners to complete a profile and may set up contracts between the prospective partners. An example of expert onboarding may be a systematic assessment of prospective experts including receiving a profile from the prospective expert, quizzing the prospective expert on their skill and experience, and facilitating courses for the expert to enroll and complete. An example of reviewer assessments may be for the onboarding system 416 to automatically review completed portions of a project. For instance, the onboarding system 416 may analyze submitted code, validate functionality of submitted code, and assess a status of the code repository. An example of expert availability management in the onboarding system 416 is to manage schedules for expert assignments and oversee expert compensation. An example of expert task allocation is to automatically assign jobs to experts that are onboarded in the onboarding system 416. For instance, the onboarding system 416 may determine a best fit to match onboarded experts with project goals and assign appropriate tasks to the determined experts.

The expert evaluation system 418 continuously evaluates developer experts. In an exemplary embodiment, the expert evaluation system 418 rates experts based on completed tasks and assigns scores to the experts. The scores may provide the experts with valuable critique and provide the onboarding system 416 with metrics with it can use to allocate the experts on future tasks.

Scheduler 420 keeps track of overall progress of a project and provides experts with job start and job completion estimates. In a complex project, some expert developers may be required to wait until parts of a project are completed before their tasks can begin. Thus, effective time allocation can improve expert developer management. Scheduler 420 provides up to date estimates to expert developers for job start and completion windows so they can better manage their own time and position them to complete their job on time with high quality.

The big resource allocation tool (BRAT 422) is capable of generating optimal developer assignments for every available parallel workstream across multiple projects. BRAT 422 system allows expert developers to be efficiently managed to minimize cost and time. In an exemplary embodiment, the BRAT 422 system considers a plethora of information including feature complexity, developer expertise, past developer experience, time zone, and project affinity to make assignments to expert developers. The BRAT 422 system may make use of the expert evaluation system 418 to determine the best experts for various assignments. Further, the expert evaluation system 418 may be leveraged to provide live grading to experts and employ qualitative and quantitative feedback. For instance, experts may be assigned a live score based on the number of jobs completed and the quality of jobs completed.

The analytics component 424 is a dashboard that provides a view of progress in a project. One of many purposes of the analytics component 424 dashboard is to provide a primary form of communication between a user and the project developers. Thus, offline communication, which can be time consuming and stressful, may be reduced. In an exemplary embodiment, the analytics component 424 dashboard may show live progress as a percentage feature along with releases, meetings, account settings, and ticket sections. Through the analytics component 424 dashboard, dependencies may be viewed and resolved by users or developer experts.

The entity controller 426 is a primary hub for entities of the software building system 100. It connects to scheduler 420, the BRAT 422 system, and the analytics component 424 to provide for continuous management of expert developer schedules, expert developer scoring for completed projects, and communication between expert developers and users. Through the entity controller 426, both expert developers and users may assess a project, make adjustments, and immediately communicate any changes to the rest of the development team.

The entity controller 426 may be linked to the interactor 112 system, allowing users to interact with a live project via an intelligent AI conversational system. Further, the interactor 112 system may provide expert developers with up-to-date management communication such as text, email, ticketing, and even voice communications to inform developers of expected progress and/or review of completed assignments.

The management components 104 provide for continuous assessment and management of a project through its entities and systems. The central hub of the management components 104 is entity controller 426. In an exemplary embodiment, core functionality of the entity controller 426 system comprises the following: display computer readable specifications configurations, provide statuses of all computer readable specifications, provide toolkits within each computer readable specification, integration of the entity controller 426 with tracker 646 and the onboarding system 416, integration code repository for repository creation, code infrastructure creation, code management, and expert management, customer management, team management, specification and demonstration call booking and management, and meetings management.

In an exemplary embodiment, the computer readable specification configuration status includes customer information, requirements, and selections. The statuses of all computer readable specifications may be displayed on the entity controller 426, which provides a concise perspective of the status of a software project. Toolkits provided in each computer readable specification allow expert developers and designers to chat, email, host meetings, and implement 3rd party integrations with users. The entity controller 426 allows a user to track progress through a variety of features including but not limited to tracker 646, the UI engine 642, and the onboarding system 416. For instance, the entity controller 426 may display the status of computer readable specifications as displayed in tracker 646. Further, the entity controller 426 may display a list of experts available through the onboarding system 416 at a given time as well as ranking experts for various jobs.

The entity controller 426 may also be configured to create code repositories. For example, the entity controller 426 may be configured to automatically create an infrastructure for code and to create a separate code repository for each branch of the infrastructure. Commits to the repository may also be managed by the entity controller 426.

Entity controller 426 may be integrated into scheduler 420 to determine a timeline for jobs to be completed by developer experts and designers. The BRAT 422 system may be leveraged to score and rank experts for jobs in scheduler 420. A user may interact with the various entity controller 426 features through the analytics component 424 dashboard. Alternatively, a user may interact with the entity controller 426 features via the interactive conversation in the interactor 112 system.

Entity controller 426 may facilitate user management such as scheduling meetings with expert developers and designers, documenting new software such as generating an API, and managing dependencies in a software project. Meetings may be scheduled with individual expert developers, designers, and with whole teams or portions of teams.

Machine learning algorithms may be implemented to automate resource allocation in the entity controller 426. In an exemplary embodiment, assignment of resources to groups may be determined by constrained optimization by minimizing total project cost. In various embodiments a health state of a project may be determined via probabilistic Bayesian reasoning whereby a causal impact of different factors on delays using a Bayesian network are estimated.

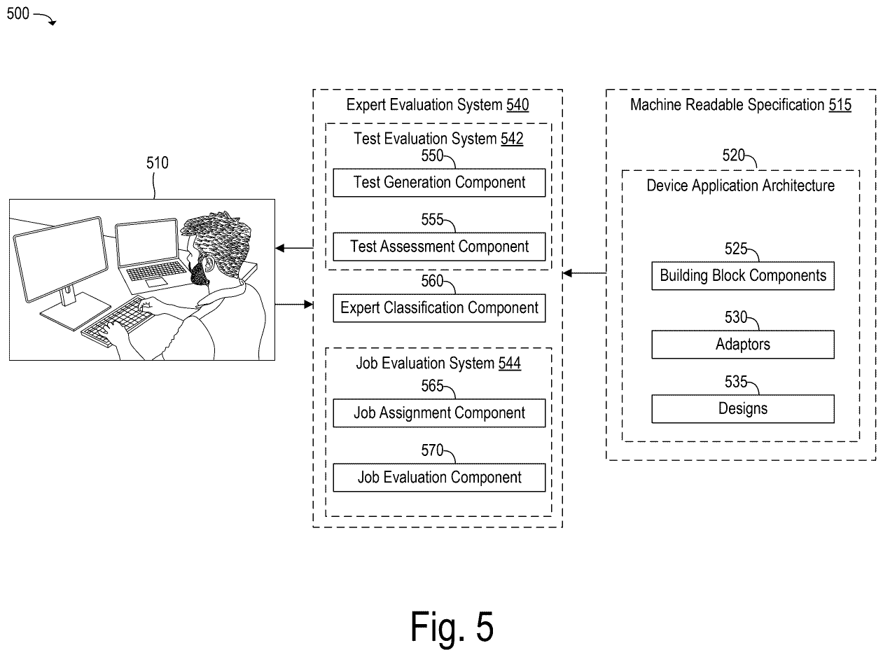

Referring to FIG. 5, FIG. 5 is a schematic 500 illustrating an embodiment of the expert evaluation system 540 in accordance with a described implementation of the disclosed subject matter. The developer 510 may be any individual that contributes to the development of a device application. The developer 510 may be a software developer, a designer, a quality engineer, or the like. The disclosed system may be used to classify one or more developers that are working on a device application. The classification may be used to assess the quality of work that employees are capable of performing. In various embodiments, the classification may be further used to match employees or developers to jobs that they are capable of performing.

In various embodiments, the disclosed subject matter may include a machine readable specification 515 for a device application. The machine-readable specification 515 may include information necessary to define one or more jobs that can be performed by the developer to contribute to the device application. For instance, the machine-readable specification 515 may include details necessary to build a building block component for the device application.

The disclosed system may include an expert evaluation system 540 that is capable of evaluating a developer 510 and evaluating jobs completed by the developer 510. In the exemplary embodiment shown in the schematic 500, the expert evaluation system 540 includes a test evaluation system 542, an expert classification component 560, and a job evaluation system 544.

The test evaluation system 542 may be used to test a developer 510 to determine the developer's 510 ability level. For instance, the test evaluation system 542 may give the developer 510 one or more tests for the developer to complete. Once completed, the test evaluation system 542 may grade the one or more tests to classify the developer 510. The test evaluation system 542 may include a test generation component 550 and a test assessment component 555. The test generation component 550 may be configured to generate one or more tests for the developer 510. In an exemplary embodiment, the test generation component 550 may generate one or more quizzes based on a developer's experience. The developer's experience may be determined based on a resume, an interview with the developer, or the like. An example of a quiz may be a test comprising one or more questions for which there is at least one correct answer. In addition to quizzes, the test generation component 550 may generate one or more assignments for the developer. An example of an assignment may be a task to complete a building block component. Another example of an assignment may be a task to design a user interface for a screen. Another example of a task may be to quality test a device application. An assignment for a developer that is a quality engineer may include conducting an analysis of a device application to identify defects or bugs in the device application. Another assignment for a developer that is a quality engineer may include making one or more improvements to a functionality of a device application or portion of a device application.

The test evaluation system 542 may transmit one or more quizzes or assignments that are generated by the test generation component 550 to the developer 510 for the developer to complete. Once completed, the developer 510 may transmit the completed quiz or assignment back to the test evaluation system 542. The test assessment component 555 may evaluate the completed quiz or assignment to determine a score or rank for the developer 510. For example, the test assessment component 555 may determine whether the developer 510 answered questions in the one or more quizzes correctly. In addition to grading quizzes, the test assessment component 555 may also evaluate assignments that are completed by the developer 510. For example, the test assessment component 555 may evaluate a completed assignment for various criteria to determine a score for the completed assignment. For instance, the test assessment component 555 may use a machine learning algorithm to evaluate a quality of an assignment to develop a software component or device application. An example of a machine learning algorithm is a neural network. In the example given above, the machine learning algorithm may evaluate a structure of the completed assignment to determine whether the structure conforms to standard industry practice. For instance, the machine learning algorithm may evaluate whether the developer 510 adhered to an entity component pattern that was called for in the assignment. The machine learning algorithm may further evaluate output based on various input for the completed assignment. For instance, if the assignment was to develop a component that accepts one or more user logins and sorts them into a database, the machine learning algorithm may test the completed component with one or more user logins to determine whether the completed assignment works properly.

The test assessment component 555 may generate a score that may be used by an expert classification component 560 to determine a classification or rank of the developer 510. The expert classification component 560 may use any combination of quiz scores and assignment scores to determine a classification for the developer 510. In various embodiments, the expert classification component 560 may weight one or more quizzes or assignments based on various criteria. For instance, the expert classification component 560 may weight a quiz that is related to a developers 510 expertise more than other quizzes or assignments. In another example, the expert classification component 560 may weight one or more quizzes or one or more assignments based on jobs that are available from the machine-readable specification 515. For instance, the expert classification component 560 may weight quizzes or assignments related to databases if there are pending jobs that require database work. A pending job may be a job that is yet to be completed. The term “pending machine readable specification”, as used herein, is a machine readable specification that includes one or more pending jobs.

The job evaluation system 544 transmits jobs to the developer 510 and assesses completed jobs that are received from the developer 510. In an exemplary embodiment, the job evaluation system 544 may include a job assignment component 565 and a job evaluation component 570. The job assignment component 565 may accept one or more jobs based on a machine-readable specification 515. In an exemplary embodiment, the machine-readable specification 515 may include one or more building block components 525, one or more adapters 530 that are designed to link the building block components 525, and one or more designs 535 for a device application. Additionally, the machine-readable specification 515 may include a device application architecture 520 that defines a structure for the building block components 525, the adapters 530, and designs 535.

One or more jobs may be resolved from the machine-readable specification 515. The jobs may be then passed by the job assessment component 565 to a developer 510 to be completed. Once completed, the developer 510 may transmit the completed job back to the job evaluation system 544. The job evaluation component 570 may assess the quality of the completed job. In an exemplary embodiment, the job evaluation component 570 comprises a machine learning algorithm that is configured to evaluate completed jobs. In various embodiments, different machine learning algorithms or models may be configured based on a type of job. For example, a machine learning algorithm may be configured to evaluate completed user interface components for device applications. For instance, a job to develop a building block component 525 that allows a user to select one or more items for purchase on a device application may be assigned to a developer 510. Once the job is completed, the job evaluation component 570 may evaluate the completed job using a machine learned algorithm that is trained to evaluate components related to user input.

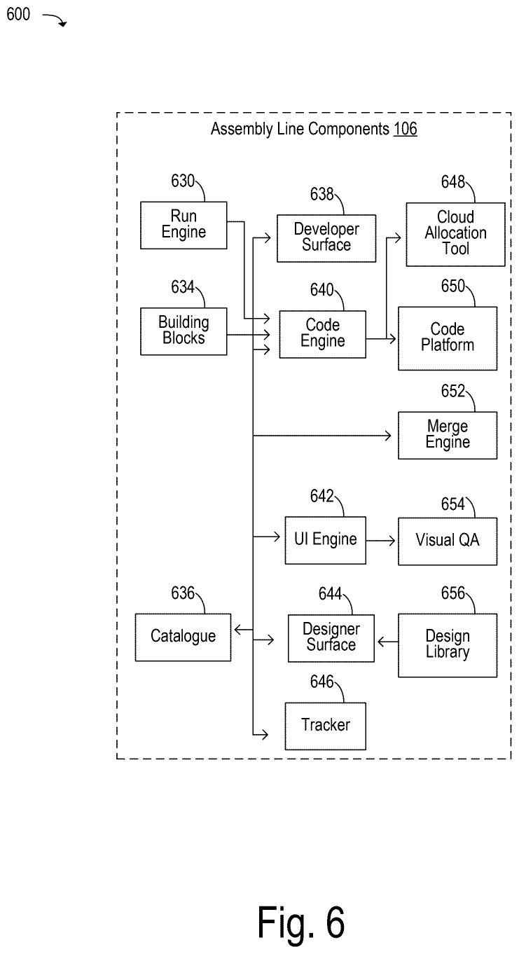

Referring to FIG. 6, FIG. 6 is a schematic 600 illustrating an embodiment of an assembly line and surfaces of the disclosed subject matter. The assembly line components 106 comprise underlying components that provide the functionality to the software building system 100. The embodiment of the assembly line components 106 includes a run engine 630, building block components 634, catalogue 636, developer surface 638, a code engine 640, a UI engine 642, a designer surface 644, tracker 646, a cloud allocation tool 648, a code platform 650, a merge engine 652, visual QA 654, and a design library 656.

The run engine 630 may maintain communication between various building block components within a project as well as outside of the project. In an exemplary embodiment, the run engine 630 may send HTTP/S GET or POST requests from one page to another.

The building block components 634 are reusable code that are used across multiple computer readable specifications. The term buildcards, as used herein, refer to machine readable specifications that are generated by specification builder 110, which may convert user specifications into a computer readable specification that contains the user specifications and a format that can be implemented by an automated process with minimal intervention by expert developers.

The computer readable specifications are constructed with building block components 634, which are reusable code components. The building block components 634 may be pretested code components that are modular and safe to use. In an exemplary embodiment, every building block component 634 consists of two sections-core and custom. Core sections comprise the lines of code which represent the main functionality and reusable components across computer readable specifications. The custom sections comprise the snippets of code that define customizations specific to the computer readable specification. This could include placeholder texts, theme, color, font, error messages, branding information, etc.

Catalogue 636 is a management tool that may be used as a backbone for applications of the software building system 100. In an exemplary embodiment, the catalogue 636 may be linked to the entity controller 426 and provide it with centralized, uniform communication between different services.

Developer surface 638 is a virtual desktop with preinstalled tools for development. Expert developers may connect to developer surface 638 to complete assigned tasks. In an exemplary embodiment, expert developers may connect to developer surface from any device connected to a network that can access the software project. For instance, developer experts may access developer surface 638 from a web browser on any device. Thus, the developer experts may essentially work from anywhere across geographic constraints. In various embodiments, the developer surface uses facial recognition to authenticate the developer expert at all times. In an example of use, all code that is typed by the developer expert is tagged with an authentication that is verified at the time each keystroke is made. Accordingly, if code is copied, the source of the copied code may be quickly determined. The developer surface 638 further provides a secure environment for developer experts to complete their assigned tasks.

The code engine 640 is a portion of a code platform 650 that assembles all the building block components required by the build card based on the features associated with the build card. The code platform 650 uses language-specific translators (LSTs) to generate code that follows a repeatable template. In various embodiments, the LSTs are pretested to be deployable and human understandable. The LSTs are configured to accept markers that identify the customization portion of a project. Changes may be automatically injected into the portions identified by the markers. Thus, a user may implement custom features while retaining product stability and reusability. In an example of use, new or updated features may be rolled out into an existing assembled project by adding the new or updated features to the marked portions of the LSTs.

In an exemplary embodiment, the LSTs are stateless and work in a scalable Kubernetes Job architecture which allows for limitless scaling that provide the needed throughput based on the volume of builds coming in through a queue system. This stateless architecture may also enable support for multiple languages in a plug & play manner.

The cloud allocation tool 648 manages cloud computing that is associated with computer readable specifications. For example, the cloud allocation tool 648 assesses computer readable specifications to predict a cost and resources to complete them. The cloud allocation tool 648 then creates cloud accounts based on the prediction and facilitates payments over the lifecycle of the computer readable specification.

The merge engine 652 is a tool that is responsible for automatically merging the design code with the functional code. The merge engine 652 consolidates styles and assets in one place allowing experts to easily customize and consume the generated code. The merge engine 652 may handle navigations that connect different screens within an application. It may also handle animations and any other interactions within a page.

The UI engine 642 is a design-to-code product that converts designs into browser ready code. In an exemplary embodiment, the UI engine 642 converts designs such as those made in Sketch into React code. The UI engine may be configured to scale generated UI code to various screen sizes without requiring modifications by developers. In an example of use, a design file may be uploaded by a developer expert to designer surface 644 whereby the UI engine automatically converts the design file into a browser ready format.

Visual QA 654 automates the process of comparing design files with actual generated screens and identifies visual differences between the two. Thus, screens generated by the UI engine 642 may be automatically validated by the visual QA 654 system. In various embodiments, a pixel to pixel comparison is performed using computer vision to identify discrepancies on the static page layout of the screen based on location, color contrast and geometrical diagnosis of elements on the screen. Differences may be logged as bugs by scheduler 420 so they can be reviewed by expert developers.

In an exemplary embodiment, visual QA 654 implements an optical character recognition (OCR) engine to detect and diagnose text position and spacing. Additional routines are then used to remove text elements before applying pixel-based diagnostics. At this latter stage, an approach based on similarity indices for computer vision is employed to check element position, detect missing/spurious objects in the UI and identify incorrect colors. Routines for content masking are also implemented to reduce the number of false positives associated with the presence of dynamic content in the UI such as dynamically changing text and/or images.

The visual QA 654 system may be used for computer vision, detecting discrepancies between developed screens, and designs using structural similarity indices. It may also be used for excluding dynamic content based on masking and removing text based on optical character recognition whereby text is removed before running pixel-based diagnostics to reduce the structural complexity of the input images.

The designer surface 644 connects designers to a project network to view all of their assigned tasks as well as create or submit customer designs. In various embodiments, computer readable specifications include prompts to insert designs. Based on the computer readable specification, the designer surface 644 informs designers of designs that are expected of them and provides for easy submission of designs to the computer readable specification. Submitted designs may be immediately available for further customization by expert developers that are connected to a project network.

Similar to building block components 634, the design library 656 contains design components that may be reused across multiple computer readable specifications. The design components in the design library 656 may be configured to be inserted into computer readable specifications, which allows designers and expert developers to easily edit them as a starting point for new designs. The design library 656 may be linked to the designer surface 644, thus allowing designers to quickly browse pretested designs for user and/or editing.

Tracker 646 is a task management tool for tracking and managing granular tasks performed by experts in a project network. In an example of use, common tasks are injected into tracker 646 at the beginning of a project. In various embodiments, the common tasks are determined based on prior projects, completed, and tracked in the software building system 100.

The assembly line components 106 support the various features of the management components 104. For instance, the code platform 650 is configured to facilitate user management of a software project. The code engine 640 allows users to manage the creation of software by standardizing all code with pretested building block components. The building block components contain LSTs that identify the customizable portions of the building block components 634.

The machine readable specifications may be generated from user specifications. Like the building block components, the computer readable specifications are designed to be managed by a user without software management experience. The computer readable specifications specify project goals that may be implemented automatically. For instance, the computer readable specifications may specify one or more goals that require expert developers. The scheduler 420 may allocate the expert developers based on the computer readable specifications or with direction from the user. Similarly, one or more designers may be hired based on specifications in a computer readable specification. Users may actively participate in management or take a passive role.

A cloud allocation tool 648 is used to determine costs for each computer readable specification. In an exemplary embodiment, a machine learning algorithm is used to assess computer readable specifications to estimate costs of development and design that is specified in a computer readable specification. Cost data from past projects may be used to train one or more models to predict costs of a project.

The developer surface 638 system provides an easy to set up platform within which expert developers can work on a software project. For instance, a developer in any geography may connect to a project via the cloud system 862 and immediately access tools to generate code. In one example, the expert developer is provided with a preconfigured IDE as they sign into a project from a web browser.

The designer surface 644 provides a centralized platform for designers to view their assignments and submit designs. Design assignments may be specified in computer readable specifications. Thus, designers may be hired and provided with instructions to complete a design by an automated system that reads a computer readable specification and hires out designers based on the specifications in the computer readable specification. Designers may have access to pretested design components from a design library 656. The design components, like building block components, allow the designers to start a design from a standardized design that is already functional.

The UI engine 642 may automatically convert designs into web ready code such as React code that may be viewed by a web browser. To ensure that the conversion process is accurate, the visual QA 654 system may evaluate screens generated by the UI engine 642 by comparing them with the designs that the screens are based on. In an exemplary embodiment, the visual QA 654 system does a pixel to pixel comparison and logs any discrepancies to be evaluated by an expert developer.

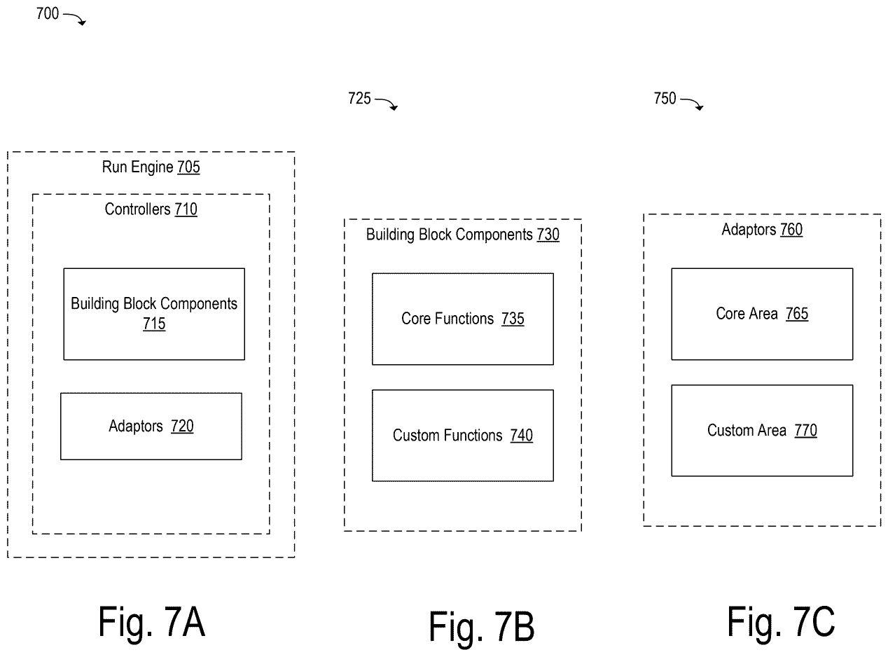

Referring to FIG. 7A, FIG. 7A is a schematic 700 for an embodiment of a run engine 705 of the disclosed subject matter. The run engine 705 facilitates the transmission of messages within the software application. Building block components 715 that make up core features of a software application are operated by the run engine 705. In various embodiments, a developer may select a multitude of building block components 715 depending on features that are desired for the software application. The run engine 705 may contain any number of building block components 715 to implement any number of features.

In an exemplary embodiment, the run engine 705 comprises one or more controllers 710. Each controller 710 may comprise one or more building block components 715 and one or more adapters 720. The controller 710 may include logic that determines an interaction between building block components 715. For instance, a controller 710 may comprise a building block component 715 that includes the functions for logging a user into a server. Logic in the controller 710 may determine when those functions are implemented. Logic in the controller may also help determine one or more functions that are implemented after the login is implemented.

The building block components 715 are software modules that comprise one or more functions for implementing features in a software application. Each building block component 715 in the controller 710 may operate independently of each other building block component 715 in the controller 710. Accordingly, removing or adding one or more building block components 715 from the controller 710 or from the software application does not impact a functionality of the other building block components 715 in the software application or controller 710. Building block components 715 may be developed in any order or in parallel in a software application. For instance, multiple developers may concurrently develop one or more building block components 715 for the same software application.

The controller 710 may include one or more adapters 720 that enable the sending and receiving of messages to and from building block components 715. Building block components 715 may communicate with other building block components 715 via the sending of messages. Adapters 720 may be used to generate messages based on output from a building block component 715. Adapters 720 may also be used to receive messages for one or more building block components 715. A single adapter 720 may be implemented to send and receive messages for one or more building block components 715.

In an example of use, when a building block component 715, which is configured to log a user into an application, completes a login, an adapter 720 may be configured to broadcast a message that a login is complete. Another building block component 715, which is configured to open a startup screen may be activated based on the login complete message. Accordingly, an adapter may receive the login complete message and activate a building block component 715 to open the start of screen.

Referring to FIG. 7B, FIG. 7B is a schematic 725 for an embodiment of a building block component 730 that may be implemented in the disclosed subject matter. A software application may include one or more building block components 730. Each building block component 730 operates independently of the other building block components 730, but may be configured to send and receive messages to and from the other building block components 730.

Each building block component 730 comprises software functions that enable one or more features in the software application. For instance, a building block component 730 for implementing a clickable button may include one or more functions, that when executed, implement a clickable button utility. Each building block component 730 may comprise one or more core functions 735 and one or more custom functions 740. The core functions 735 may be configured to be un-editable in a building block component 730. A developer may be encouraged to include one or more custom functions 740 in a building block component 730 to implement functionality or features that are specific to their software application.

Each of the core functions 735 and custom functions 740 may be configured so as not to depend on functionality from other building block components 730. Thus, each of the building block components 730 may be developed independently. This may allow for rapid development as building block components 730 may be developed concurrently by multiple developers. Further, building block components 730 may be configured to implement specific features in an application that are common to multiple applications.

Thus, a single building block component 730 may be developed to be used as a utility. A developer may choose to include a preconfigured building block component 730 based on features that the developer desires in the software application. A completed software application may be further developed by adding additional building block components 730 because the additional building block components 730 do not depend on any of the existing building block components 730. Further, adding additional building blocks to a software application will not break any of the functionality of the software application.

Referring to FIG. 7C, FIG. 7C is a schematic 750 for an embodiment of an adapter 760 that may be implemented in the disclosed subject matter. Building block components 730 may be configured not to depend on any functions of other building block components 730. However, a building block component may be configured to receive messages that are generated by another building block component 730. The transmission of messages from one building block component 730 to another is facilitated by the adapters 760.

Adapters 760 allow for building block components 730 to be interconnected without being interdependent on functionality. A building block component 730 may generate a message that is to be received by another building block component 730. An adapter 760 may be configured to broadcast a message from one building block component 730 and another adapter 760 may be configured to listen for the message. For example, the adapter 760 may be configured to subscribe to one or more messages, where subscribing puts the adapter in a state that causes the adapter 760 to perform an action when it receives the message. The terms listening and subscribing, as used herein, are used interchangeably as they apply to the adapters 760.

In various embodiments, an adapter may be configured to broadcast data that is nested in a message. For instance, an adapter may broadcast a message to open a checkout screen for a shopping application. The message to open the checkout screen may be received by an adapter 760 that executes one or more functions on a building block component 634 that operates the checkout screen. The message may further include nested data such as one or more shopping items that the user selected. The nested data may be received by the adapter 760 along with the message to be transmitted to the building block component 730 that implements the checkout screen.

Like building block components 730, the adapters 760 may each include a core area 765 and a custom area 770. The core area 765 may include one or more functions that facilitate sending and receiving messages with the adapter 760. In various embodiments, an adapter may have a listen function whereby any adapter may be configured to listen for one or more messages that may be transmitted within the run engine 705. In an example of use, an adapter 760 is configured to listen for a “LOGIN_COMPLETE” message. When the adapter 760 receives the “LOGIN_COMPLETE” message, it executes one or more functions in a building block component 730.

The custom area 770 in each adapter 760 may be utilized to implement logic in a software application. For example, the custom area may be edited to execute one or more functions of a building block upon receiving a message from the run engine 705. In another example, logic may be implemented to broadcast one or more messages responsive to execution of functions in a building block component 730.

In various embodiments, the customer logic area may be configurable by a machine readable specification. For example, a machine readable specification may specify that execution of a function by a first building block component triggers execution of a function by a second building block component. Accordingly, a computer system may automatically insert logic into a first adapter that causes the adapter to transmit a message responsive to the first building block component executing the function. The machine readable specification may further insert logic into a second adapter that causes the second adapter to listen for the message and cause the second building block component to execute a function responsive to receiving the message.

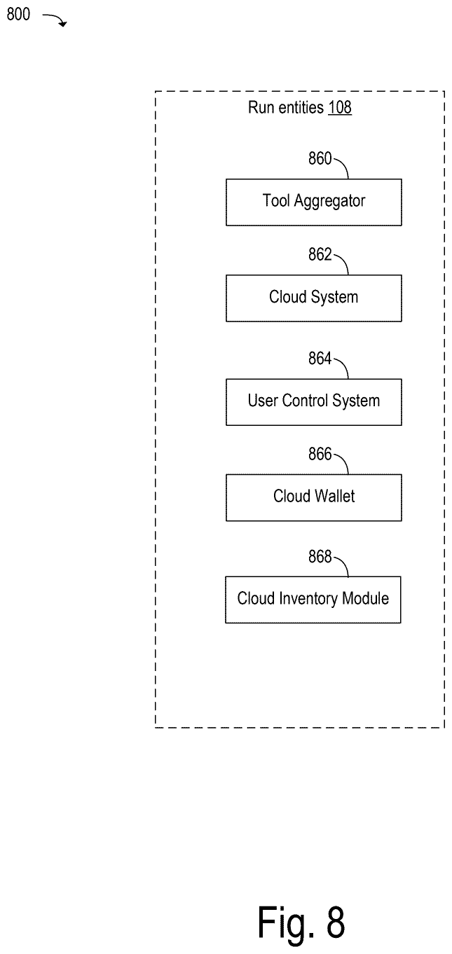

Referring to FIG. 8, FIG. 8 is a schematic 800 illustrating an embodiment of the run entities 108 of the disclosed subject matter. The run entities 108 contain entities that all users, partners, expert developers, and designers use to interact within a centralized project network. In an exemplary embodiment, the run entities 108 include tool aggregator 860, cloud system 862, user control system 864, cloud wallet 866, and a cloud inventory module 868. The tool aggregator 860 entity brings together all third-party tools and services required by users to build, run and scale their software project. For instance, it may aggregate software services from payment gateways and licenses such as Office 365. User accounts may be automatically provisioned for needed services without the hassle of integrating them one at a time. In an exemplary embodiment, users of the run entities 108 may choose from various services on demand to be integrated into their application. The run entities 108 may also automatically handle invoicing of the services for the user.

The cloud system 862 is a cloud platform that is capable of running any of the services in a software project. The cloud system 862 may connect any of the entities of the software building system 100 such as the code platform 650, developer surface 638, designer surface 644, catalogue 636, entity controller 426, spec builder 110, the interactor 112 system, and the prototype module 114 to users, expert developers, and designers via a cloud network. In one example, cloud system 862 may connect developer experts to an IDE and design software for designers allowing them to work on a software project from any device.

The user control system 864 is a system requiring the user to have input over every feature of a final product in a software product. With the user control system 864, automation is configured to allow the user to edit and modify any features that are attached to a software project regardless as to the coding and design by developer experts and designer. For example, building block components 634 are configured to be malleable such that any customizations by expert developers can be undone without breaking the rest of a project. Thus, dependencies are configured so that no one feature locks out or restricts development of other features.

Cloud wallet 866 is a feature that handles transactions between various individuals and/or groups that work on a software project. For instance, payment for work performed by developer experts or designers from a user is facilitated by cloud wallet 866. A user need only set up a single account in cloud wallet 866 whereby cloud wallet handles payments of all transactions.

A cloud allocation tool 648 may automatically predict cloud costs that would be incurred by a computer readable specification. This is achieved by consuming data from multiple cloud providers and converting it to domain specific language, which allows the cloud allocation tool 648 to predict infrastructure blueprints for customers' computer readable specifications in a cloud agnostic manner. It manages the infrastructure for the entire lifecycle of the computer readable specification (from development to after care) which includes creation of cloud accounts, in predicted cloud providers, along with setting up CI/CD to facilitate automated deployments.

The cloud inventory module 868 handles storage of assets on the run entities 108. For instance, building block components 634 and assets of the design library are stored in the cloud inventory entity. Expert developers and designers that are onboarded by onboarding system 416 may have profiles stored in the cloud inventory module 868. Further, the cloud inventory module 868 may store funds that are managed by the cloud wallet 866. The cloud inventory module 868 may store various software packages that are used by users, expert developers, and designers to produce a software product.

The run entities 108 provides a user with 3^{rd} party tools and services, inventory management, and cloud services in a scalable system that can be automated to manage a software project. In an exemplary embodiment, the run entities 108 is a cloud-based system that provides a user with all tools necessary to run a project in a cloud environment.

For instance, the tool aggregator 860 automatically subscribes with appropriate 3^{rd} party tools and services and makes them available to a user without a time consuming and potentially confusing set up. The cloud system 862 connects a user to any of the features and services of the software project through a remote terminal. Through the cloud system 862, a user may use the user control system 864 to manage all aspects of a software project including conversing with an intelligent AI in the interactor 112 system, providing user specifications that are converted into computer readable specifications, providing user designs, viewing code, editing code, editing designs, interacting with expert developers and designers, interacting with partners, managing costs, and paying contractors.

A user may handle all costs and payments of a software project through cloud wallet 866. Payments to contractors such as expert developers and designers may be handled through one or more accounts in cloud wallet 866. The automated systems that assess completion of projects such as tracker 646 may automatically determine when jobs are completed and initiate appropriate payment as a result. Thus, accounting through cloud wallet 866 may be at least partially automated. In an exemplary embodiment, payments through cloud wallet 866 are completed by a machine learning AI that assesses job completion and total payment for contractors and/or employees in a software project.

Cloud inventory module 868 automatically manages inventory and purchases without human involvement. For example, cloud inventory module 868 manages storage of data in a repository or data warehouse. In an exemplary embodiment, it uses a modified version of the knapsack algorithm to recommend commitments to data that it stores in the data warehouse. Cloud inventory module 868 further automates and manages cloud reservations such as the tools providing in the tool aggregator 860.

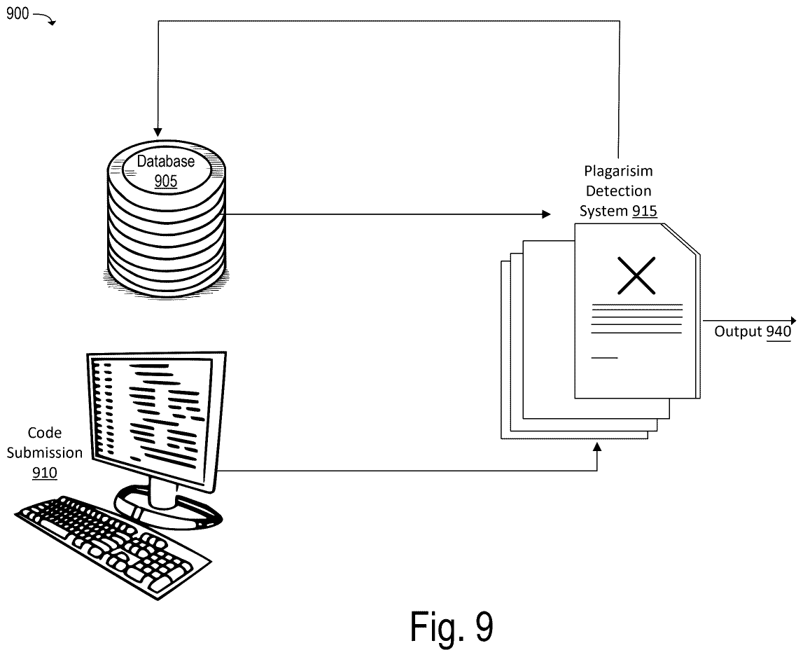

Referring to FIG. 9, FIG. 9 is a schematic illustration 900 of an example of an embodiment using a plagiarism detection system. The plagiarism detection system may be used to process code samples to determine if they've been plagiarized from code samples that are stored in a database 905. The plagiarism detection system may be used by entities such as companies, academic institutions, or the like, to test codes or portions of codes to determine if they have been plagiarized. The term “plagiarize,” as used herein, refers to copying the substantive portions of a code into another code contrary to the wishes or intentions of a hiring client. The hiring client may be an employer, company, contractor, academic institution, class, or the like. Plagiarism may occur even when the code is changed in ways that do not modify the overall function of the code. For instance, variable names, function names, overall order of various functions or classes within a code may be modified without changing the overall function of the code. The plagiarism detection system 915 is capable of detecting plagiarized code in instances where such minor modifications are made. The submitted code samples are processed through the code submission system 910 and then analyzed by the plagiarism detection system 915, which compares them against the historical code samples stored in the database 905. In some embodiments, the output 940 of the plagiarism detection system 915 is an estimated probability, which indicates whether the submission is plagiarized or not.

In an example of use, a hiring client may submit a task to a developer to develop a program or a portion of a program, such as a building block for a program. The developer may work on the task and submit a code submission back to the hiring client. Once received, the hiring client may process the code submission in the plagiarism detection system 915 to determine if all of the code or a portion of the code is plagiarized.

The plagiarism detection system 915 operates by breaking the submitted code down into sequences of operators and keywords. The operators and keywords that are selected for any analysis may be specific to the project Examples of operators that may be used in a C++ code include the plus sign operator (+), minus sign operator (−), multiplication sign operator (*), divide sign operator (/), modulus operator (%), increment operator (++), decrement operator (−−), assignment operator (=), equality operator (==), not equal operator (!=), greater than operator (>), less than operator (<), greater than or equal to operator (>=), less than or equal to operator (<=), logical AND operator (&&), logical OR operator (||), bitwise AND operator (&), bitwise OR operator (|), bitwise XOR operator (\hat{ }), bitwise NOT operator (˜), left shift operator (<<), right shift operator (>>), parentheses (( )), colons (:), and brackets ([ ]). Examples of reserved keywords that may be used for the C++ programming language include alignas, alignof, and, and_eq, asm, auto, bitand, bitor, bool, break, case, catch, char, char8_t, char16_t, char32_t, class, compl, const, consteval, constexpr, constinit, const_cast, continue, co_await, co_return, co_yield, decltype, default, delete, do, double, dynamic_cast, else, enum, explicit, export, extern, false, float, for, friend, goto, if, inline, int, long, mutable, namespace, new, noexcept, not, not_eq, nullptr, operator, or, or_eq, private, protected, public, register, reinterpret_cast, requires, return, short, signed, sizeof, static, static_assert, static_cast, struct, switch, template, this, thread_local, throw, true, try, typedef, typeid, typename, union, unsigned, using, virtual, void, volatile, wchar_t, while, xor, and xor_eq.

Sequences of the operators and keywords are analyzed for matching sequences or sub-sequences. In various embodiments, a threshold for the number of operators and keywords that match in a sequence may be set. For example, a threshold of fifteen to twenty operators and keywords may be set such that a matching sequence of fifteen to twenty keywords and operators between two sets of code may trigger or may be recorded as a matching sequence. Accordingly, unsubstantive portions (such as comments, variable names, function names, and the like) of the code that are caught during a plagiarism detection process are not counted. Portions of code that may be rearranged, such as the order of functions or classes within a code, still retain the same sequence within the function or class and are detected as matching sequences.

Various algorithms may be used to compare sequences to determine matching portions of sequences. An example of an algorithm may be a hashing algorithm. In various embodiments, a dynamic programming algorithm may be employed to determine matching sequences of keywords and operators. A dynamic programming algorithm, as used herein, refers to an algorithm that breaks an analysis down into subparts, where every subpart that is completed is memorialized so that it does not need to be performed again. In an exemplary embodiment, the dynamic programming algorithm used is a time-and-space algorithm, O(N²). O(N²) compares every character in a sequence to every character in another sequence. The time-and-space O(N²) algorithm scales quadratically with the size of a sample and could be fairly expensive for extremely large samples. However, the nature of the plagiarism detection system scales down the complexity of code by distilling it down into operators and keywords, which makes the analysis far more manageable. Various other algorithms may be employed to determine matching sequences.

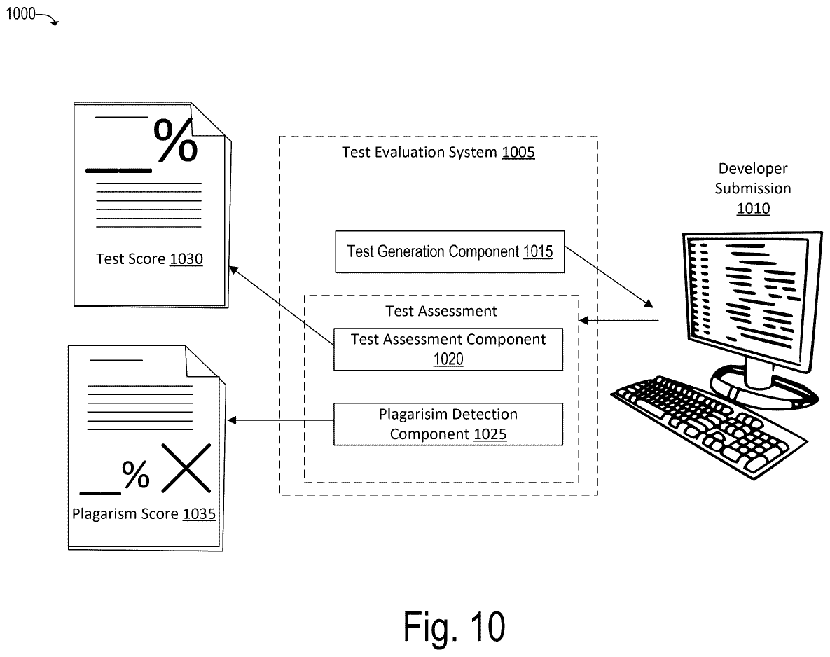

Referring to FIG. 10, FIG. 10 is a schematic illustration 1000 of a system for evaluating developers by testing them with an assignment. The system may be employed by a corporation, academic institution, or other entity to test or otherwise evaluate the coding ability of a developer in any area. In an exemplary embodiment, the Disclosed Test Evaluation System 1005 may be used to determine whether a developer has the expertise to perform at a certain level. The Test Evaluation System 1005 may also be used to rank a developer. The ranking may be used to rank developers within a group of developers. The ranking may also be used to determine whether a developer is competent to perform certain projects. The projects themselves may have a rank, and the rank of the developer may correspond to the rank of the project.

The test evaluation system 1005 may include a test generation component 1015, a test assessment component 1020, and a plagiarism detection component 1025. The test generation component 1015 may generate a test appropriate for a developer. For example, a company may wish to gauge the ability of a developer and generate a test in a certain specific area. For instance, a developer for ReactJS may receive a test that tests their ability using React. Accordingly, the test generation component 1015 would be configured to construct a test based on React or a test that assesses the developer's ability to develop code in React. The test generated by the test generation component 1015 would then be displayed to the developer for submitting the code corresponding the test in the developer submission system 1010. The developer would produce the code based on the assignment generated by the test generation component 1015 and produce a developer submission. The test evaluation system 1005 would then assess the code submission using the test assessment component 1020 and the plagiarism detection component 1025.

The test assessment component 1020 may be configured to grade the test or the code submission based on the task given by the test generation component 1015. For instance, if a developer is tasked by the test generation component 1015 to produce a TypeScript module that communicates with an AWS system to perform a login, the test assessment component 1020 would determine whether the submitted code accomplished the task or tasks given. The test assessment component 1020 may grade the developer submission in various ways, such as overall structure, comments, as well as function and efficiency of the developer submission. The plagiarism detection component 1025 may be used concurrently with the test assessment component 1020. The plagiarism detection component 1025 may determine whether the developer submission is plagiarized in whole or in part. As discussed above, the plagiarism detection component 1025 breaks the developer submission down into sequences or a sequence of operators and keywords. The sequence of operators and keywords is then compared to a database, such as a database of previous submissions in a code repository in an exemplary embodiment. The developer submission is compared against previous developer submissions for similar test generations.

In the embodiment shown in the illustration, the test evaluation system 1005 may produce various reports or scores for the developer submission. For example, the test evaluation system 1005 may produce a test score 1030 and a plagiarism score 1035. The test score 1030 may be a score showing whether or not the developer accomplished the task given by the test generation component 1015. The test score 1030 may also rank the developer to show the level of expertise the developer has in the specific test assigned by the test generation component 1015. The plagiarism score 1035 may show whether or not the test is plagiarized. In various embodiments, the plagiarism score 1035 may also compute a ratio of plagiarized code to total code. In various embodiments, the plagiarism detection component 1025 may be configured with a threshold, whereby a ratio beyond the threshold will trigger an alert. For instance, the plagiarism detection component 1025 may include multiple thresholds that represent various levels of plagiarism from mild to extreme. An example of a threshold may be that 15% of the sequences of operators and keywords in a developer submission are determined to be plagiarized or otherwise copied from a previous submission in a code repository.

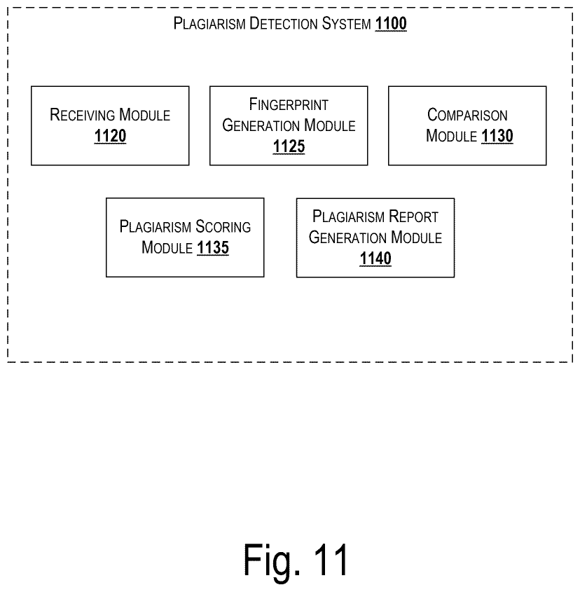

Referring to FIG. 11. FIG. 11 is a schematic of an example of a plagiarism detection system 1100 that may be used to detect plagiarism in a code sample. The various components of the plagiarism detection system 1100 shown in FIG. 11 may be included to perform various aspects of plagiarism detection. In various embodiments, the various modules and components of the plagiarism detection system 1100 may be organized differently. In the example embodiment of the plagiarism detection system 1100 shown in FIG. 11, the plagiarism detection system 1100 includes a receiving module 1120, a fingerprint generation module 1125, a comparison module 1130, a plagiarism scoring module 1135, and a plagiarism report generation module 1140.

The receiving module 1120 may receive a developer submission, as well as various codes to compare to the developer submission. In various embodiments, the receiving module 1120 may be configured to determine a programming language for the developer submission, and determine appropriate codes with which to compare the developer submission. For instance, a developer submission in JavaScript may trigger the receiving module 1120 to download JavaScript codes from a code repository. In some instances, the receiving module 1120 may receive a specific assignment from the test evaluation system, and accordingly refine the codes that are downloaded from the database or repository with which to compare to the developer submission. For instance, if a developer is given a task in an assignment to develop a TypeScript module that communicates with AWS to perform a login function, the receiving module 1120 may be configured to download previous developer submissions from a code repository that were produced in response to similar tasks.

The fingerprint generation module 1125 may be used to break codes down into operators and reserved keywords. The sequence of the operators and reserved keywords is referred to as the fingerprint for the code. Both the developer submission and the codes with which it is compared may be broken down similarly by the fingerprint generation module 1125. In various embodiments, the fingerprint generation module 1125 may be configured to break down codes written using different programming languages and normalize them. For instance, when comparing two codes where one is written in Python and the other is written in JavaScript, the fingerprint generation module 1125 may normalize the code such that certain syntax in Python and JavaScript are normalized to be equivalent. For instance, an indentation operation in Python may be normalized to become brackets in order to compare the Python sequence with a JavaScript sequence. The fingerprint generation module 1125 may output a sequence of reserved keywords and operators for each code received by the receiving module 1120.

The comparison module 1130 may receive sequences of code from the fingerprint generation module 1125 and compare them to determine the numbers of sequences that are equivalent. In various environments, the comparison module 1130 may compare the sequences using a dynamic programming algorithm, such as the time-and-space algorithm, O(N²). Using the time-and-space algorithm, the comparison module 1130 may output all matching sequences, regardless of the order or location of the subsequence within the sequence as a whole. Accordingly, a code that is plagiarized but reorders various portions of the code or copied code will be caught by the comparison module 1130.

The plagiarism scoring module 1135 may accept the matching sequences as determined by the comparison module 1130 and determine a plagiarism score for each developer submission. In an exemplary embodiment, the plagiarism score is determined as a ratio of matching sequences to total sequence. For instance, if 10% of a developer submission contains sequences of code that match a sequence of code in a code repository, the plagiarism scoring module 1135 will output that ratio. The plagiarism scoring module 1135 may be configured with various thresholds. For instance, it may be determined that a ratio below a certain threshold is acceptable. For example, certain coding practices may inherently lend themselves to similar coding sequences between codes. The plagiarism scoring module 1135 may output the result of the score to the plagiarism report generation module 1140. The plagiarism report generation module 1140 may prepare an output that is configured to be read. For example, the plagiarism report generation module 1140 may output a threat level or plagiarism level based on the ratio as determined by the plagiarism scoring module 1135. The various thresholds for ratios in the plagiarism scoring module 1135 may be used to determine a plagiarism score. For example, a ratio of greater than 10% plagiarism may result in a moderate plagiarism level. A ratio of greater than 20% plagiarism may result in a high plagiarism level. A ratio of greater than 30% plagiarism may result in an extreme plagiarism level. Accordingly, the plagiarism report generation module 1140 may output the result of the plagiarism scoring module 1135 and distill it down into an easy-to-read assessment.

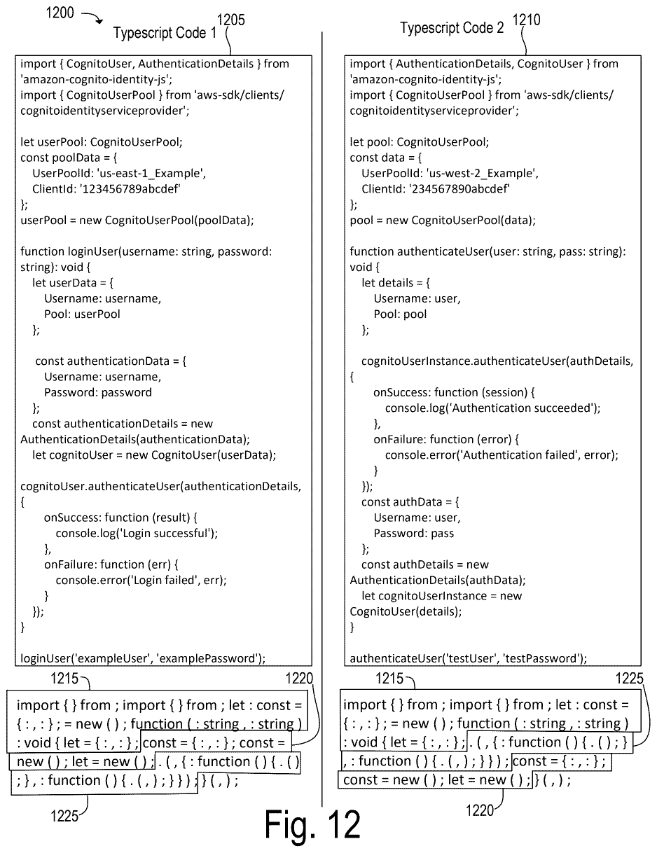

Referring to FIG. 12, FIG. 12 is a set of code samples 1200 that may be analyzed by the plagiarism detection system. The plagiarism detection system may process various pairs of code samples to determine the number of matching sequences of operators and keywords in the codes. One of the processes of the plagiarism detection system is that it breaks down each set of software codes to a set of operators and reserved keywords. The specific operators and reserved keywords may change based on the plagiarism analysis, programming language, or a combination thereof.

The set of code samples 1200 include a first TypeScript code 1205 and a second TypeScript code 1210. Underneath each TypeScript code is the sequence of operators and reserved keywords for the respective TypeScript code. The plagiarism detection system may process all software code that it receives into operators and reserved keywords. The specific operators and reserved keywords may be stored in a JSON or JSX file that the plagiarism detection system uses to extract operators and reserved keywords from each code sample. The sequence of operators and reserved keywords may be stored as a single line of tokens where each token represents an operator or a reserved keyword. The term “tokenization,” as used herein, may refer to the process of converting each of the operators and reserved keywords into a sequence.

The plagiarism detection system may process the sequence of operators and reserved keywords to determine matching sequences of operators and reserved keywords. Some embodiments of the plagiarism detection system may include a threshold number of operators and reserved keywords that are required to trigger a matching sequence. For example, a matching set of operators and reserved keywords greater than fifteen operators and reserved keywords that match between code samples may trigger the plagiarism detection system to identify the sequence as matching.

As shown in the code sample 1200, the sequences of operators and reserved keywords include a first matching subsequence 1215, a second matching subsequence 1220, and a third matching subsequence 1225. Accordingly, the system may determine that approximately 90% of one of the TypeScript codes is plagiarized from the other. However, it may be noted that the second matching subsequence 1220 and third matching subsequence 1225 are reversed between the first TypeScript code 1205 and second TypeScript code 1210. The plagiarism detection system 1100 is configured to identify such rearrangements in code samples.

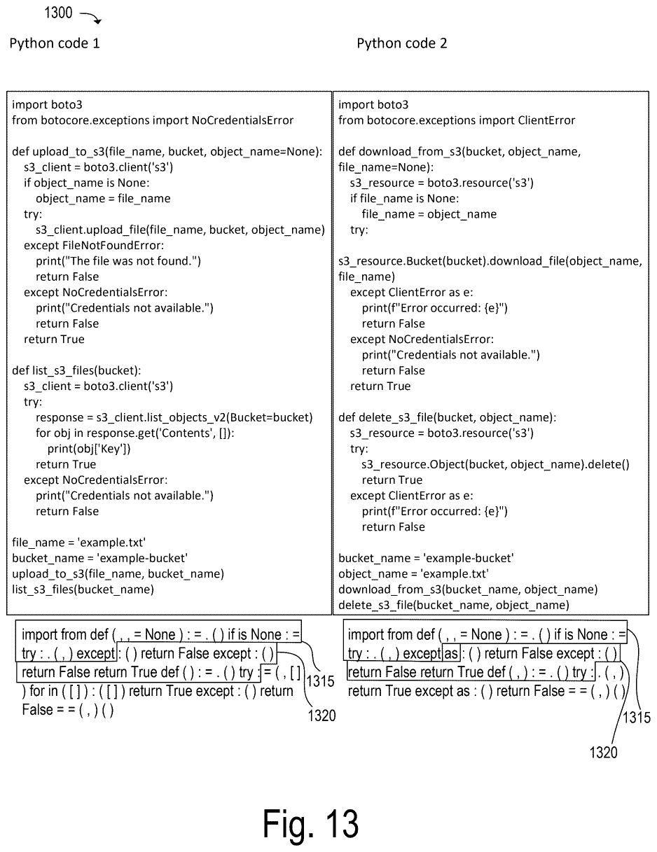

Referring to FIG. 13, FIG. 13 includes code samples of Python code 1300 that may be processed by the plagiarism detection system to determine whether or not the second Python code 1310 is plagiarized from the first Python code 1305. If the plagiarism detection system determines that there is at least some plagiarism in the second Python code 1310, it may further determine the extent of plagiarism in the second Python code 1310. Each programming language may include different operators and reserved keywords. Further, the syntax of various programming languages, such as indentation in Python, may also be converted into an operator by the plagiarism detection system.

Like FIG. 12, the sequence of operators and reserved keywords is printed underneath each Python code sample. The plagiarism detection system may process each Python code sample to tokenize the Python code samples into the sequence of operators and reserved keywords. It may further process the sequence of operators and reserved keywords to determine any matching sequences or subsequences. As indicated by the boxed portions of the sequences underneath the Python codes, the two code samples include a first matching subsequence 1315 and a second matching subsequence 1320. In various embodiments, a user may choose to exclude one or more operators or reserved keywords based on the needs of the project. In the code samples shown in FIG. 13, the operator “as” may be excluded in order to show that the first matching subsequence 1315 and second matching subsequence 1320 are essentially one matching subsequence and that the inclusion of the operator “as” did not modify the two codes in a substantive way.

The plagiarism detection system may further process the matching subsequences to determine the extent of plagiarism in the code samples. For example, the plagiarism detection system may determine a percentage of plagiarism in each of the code samples. In this case, approximately 70% of the sequence of reserved keywords and operators in the second Python code 1310 is identical to the sequence of reserved keywords and operators in the first Python code 1305. Accordingly, the plagiarism detection system may determine that the extent of plagiarism in the second Python code sample is extremely high. The plagiarism detection system may issue a report that identifies the second Python code 1310 as such.

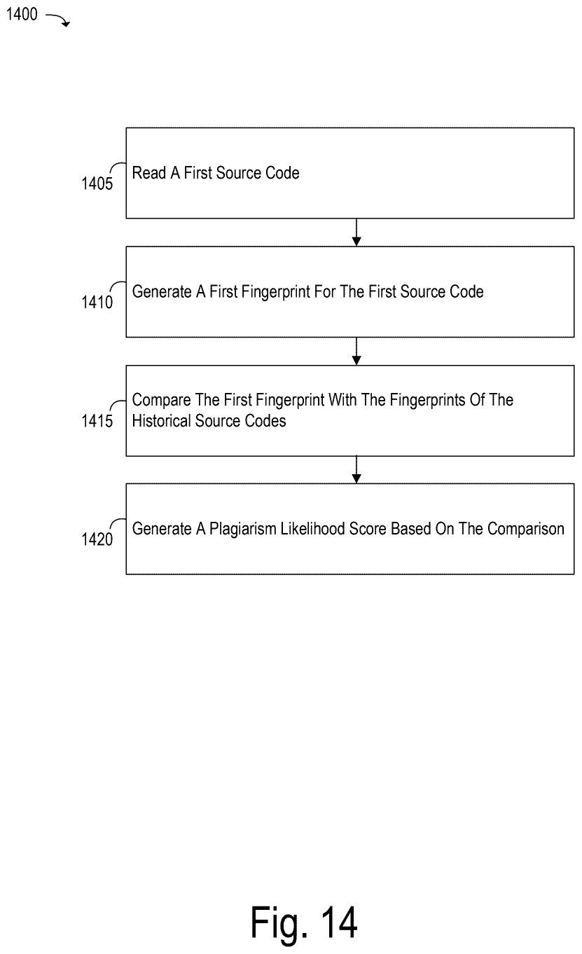

Referring to FIG. 14, FIG. 14 is a flow diagram of a process 1400 for determining a plagiarism likelihood in source code. The process 1400 may be used to analyze source code that is submitted to an entity such as a company, an academic institution, or other entity, and verify that the source code is not plagiarized in any substantive way. As discussed above, developers may take pre-existing source code and modify it in unsubstantive ways such as changing variable names, function names, class names, or rearranging the order of operations or definitions in the source code. The disclosed process 1400 is configured to catch such unsubstantive changes and verify that the source code is not plagiarized in any substantive way.

At step 1405 of the process 1400, the process may read a first source code. In various embodiments, the process may, or a computer-automated system may, receive a submission of a source code from a developer. In various embodiments, a computer system may retrieve the first source code from a code repository, such as GitLab.

At step 1410 of the process 1400, the process may generate a first fingerprint for the first source code. An embodiment of the first fingerprint may include breaking the first source code down into a sequence of operators and reserved keywords, and discarding everything else, such as spaces, variable names, function names, or the like. The operators and reserved keywords may be determined based on the programming language used and the needs of the specific plagiarism analysis that is to be done. In an example embodiment, the operators and reserved keywords may be stored in a JSON file or JSX file and read to generate the first fingerprint.

At step 1415 of the process 1400, the process may compare the first fingerprint with fingerprints of historical source codes. In an example embodiment, the comparison may comprise determining matching sequences of operators and reserved keywords between the first fingerprint and fingerprints of historical source codes. In an example of use, a dynamic programming algorithm may be used to perform the comparison. An example of a dynamic programming algorithm may be the time-and-space algorithm O(N²).

At step 1420 of the process 1400, the process may generate a plagiarism likelihood score based on the comparison. For example, the plagiarism likelihood score may be based on a percentage of matching sequences in the first fingerprint that match sequences in one or more historical source codes. The plagiarism likelihood score may be based on the magnitude of the percentage. In another embodiment, the plagiarism likelihood score is based on a ratio of matching sequences to total sequences. Once again, the magnitude of the ratio may determine the plagiarism likelihood score. A higher percentage or ratio would be more indicative of plagiarism. In various embodiments, the plagiarism likelihood score is ranked at various levels, such as low, medium, and high, whereby a threshold percentage or ratio is set for the various plagiarism levels, whereby zero would be a no plagiarism level, above 10% would be a low plagiarism level, above 20% would be a medium plagiarism level, and above 30% would be a high plagiarism level. The various thresholds may be modified based on the needs of the plagiarism analysis.

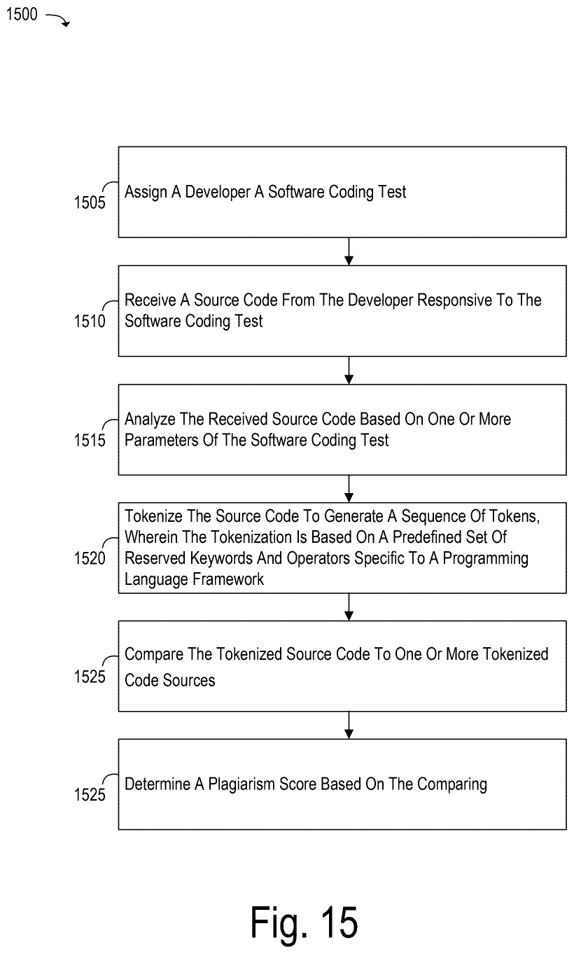

Referring to FIG. 15, FIG. 15 is a flow diagram of a process 1500 for assessing a software developer. The process 1500 may be implemented to assess the skills of a developer, as well as whether a code submission by the developer has been plagiarized. Skilled software developers are highly coveted by various institutions such as companies in software development. Accordingly, assessing the skill of a software developer or potential software developer is a useful aid to such companies. In addition to assessing the skill of the developer, the disclosed process 1500 also determines whether or not any submitted code from the developer is plagiarized.

At step 1505 of the process 1500, the process may assign a developer a software coding test. In various environments, the software coding test is assigned to the developer by an automated process that automatically generates a coding assignment based on various criteria that are set for the developer. The various criteria may include the programming language and various projects within the programming language that the software developer or developer may expect to see. For example, a software developer using TypeScript may expect projects using ReactJS.

At step 1510 of the process 1500, the process may receive a source code from the developer based on the software coding test. For example, after the developer is assigned the coding test in step 1505, the developer may produce the source code based on the assignment. The developer may then submit the source code so that the source code can be assessed.

At step 1515 of the process 1500, the process may analyze the received source code based on one or more parameters of the software coding test. The analysis of the received source code may be a grade or determination of whether or not the developer passed the software coding test. In various embodiments, the analysis of the received software code is done by an automated process that executes the code and determines whether or not the developer actually produced code that would perform the assigned assignment. The one or more parameters of the software coding test may be any parameters that could be used to assess whether or not the developer actually performed the assignment or tasks that were assigned to the developer. In an example embodiment, the one or more parameters may include producing a code that performs one or more actions. An example of an action may be a login action, so that the code, when executed, performs a login function. In an example embodiment, the code is analyzed by an automated process that compiles and executes the code to determine whether the one or more parameters have been satisfied by the code. In an example embodiment, the analysis of the received source code may include ranking the developer or the ability of the developer. For example, the analysis may include ranking the developer as novice, intermediate, or expert based on the coding assignment. For instance, the analysis may include judging the code based on the one or more parameters and ranking the code accordingly. An example of whether the code receives a high rank or a low rank may be whether or not the code satisfies a number of parameters. For example, a code that satisfies some but not all parameters may be ranked as novice. A code that satisfies substantially all parameters may be ranked as intermediate. And a code that satisfies every parameter may be ranked as expert.

At step 1520, the process 1500 may tokenize the source code to generate a sequence of tokens, where the tokenization is based on a predefined set of reserved keywords and operators specific to a programming language framework. Accordingly, the tokenization may break down the source code into a sequence of operators and reserved keywords specific to a programming language. The operators and keywords for the C++ programming language are listed above. Various operators and reserved keywords may be excluded or included based on the needs of a specific project. In yet more embodiments, various operators and reserved keywords may be excluded based on their value as tokens. For example, a machine learning algorithm may be executed to determine tokens such as operators and reserved keywords that have little value in the plagiarism analysis of a pair of source codes.

At step 1525 of the process 1500, the process may compare the tokenized source code to one or more tokenized code sources. For example, the tokenized source code, which is broken down into a sequence of operators and reserved keywords, may be compared to other sequences of operators and reserved keywords based on other code sources to determine how many sequences are matching and the length of matching sequences. In various embodiments, a dynamic programming algorithm may be used to compare or perform the comparison.

At step 1525 of the process 1500, the process 1500 may determine a plagiarism score based on the comparing. For example, the comparison may determine an amount of plagiarism in the tokenized source code based on the amount of matching sequences or matching subsequences with the tokenized source code and in one or more other tokenized source codes. For example, if one or more tokenized or other tokenized code sources has a substantially high number of matching subsequences to the tokenized source code, the process 1500 may determine a high plagiarism score. Likewise, if there are a low number of matching subsequences, the process 1500 may determine a low plagiarism score. If there are no matching subsequences, the process 1500 may determine a zero plagiarism score. In various embodiments, the plagiarism score may be a percentage of matching subsequences compared to the total length of a sequence. In various embodiments, the plagiarism score may be based on a ratio of matching subsequences compared to the total length of a sequence of operators and reserved keywords.

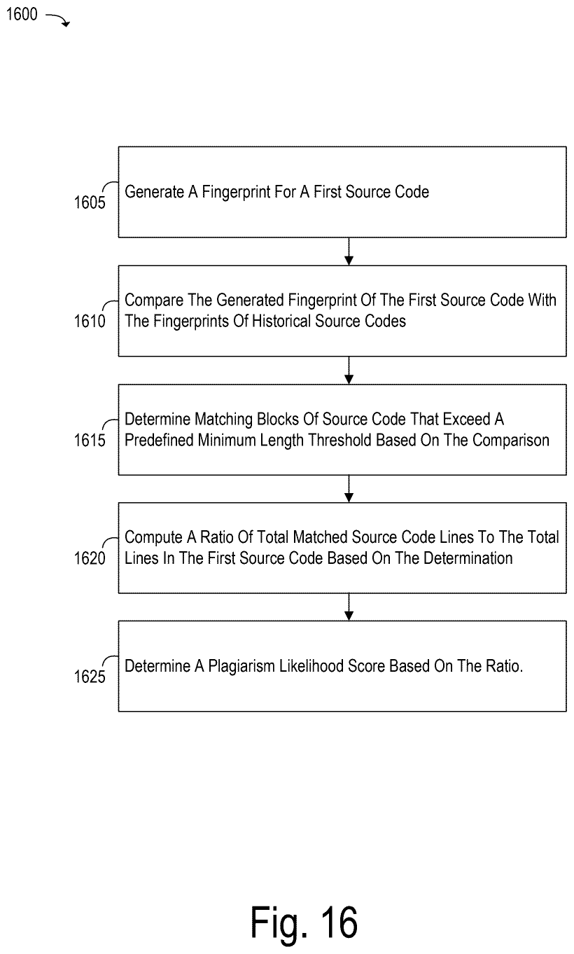

Referring to FIG. 16, FIG. 16 is a flow diagram of a process 1600 for determining a plagiarism likelihood based on a fingerprint of software code. The process 1600 may be used to create an identifiable characteristic of a software developer based on their software coding style. That characteristic may be referred to herein as the fingerprint of the developer. The fingerprint excludes various unsubstantive portions of code, such as variable names, function names, and order of operations or order of functions in a code. Instead, the fingerprint is based on a sequence of operators and reserved keywords.

At step 1605 of the process 1600, the process 1600 may generate a fingerprint for a first source code. The fingerprint may be the sequence of operators and reserved keywords for the source code. The operators and reserved keywords may be specific to the programming language and/or the specific task or project that is being analyzed for plagiarism. In various embodiments, various operators and keywords may be excluded or included based on a machine learning analysis of which operators and keywords are most relevant to a plagiarism analysis.

At step 1610 of the process 1600, the process may compare the generated fingerprint of the first source code with the fingerprints of historical source codes. The comparison may include determining matching subsequences of the fingerprints of the first source code and historical source codes. A subsequence may refer to a sequence of reserved keywords and operators of the source code that is a subset of the entire sequence of reserved keywords and operators of the source code. The number of matching subsequences and length of matching subsequences may all be relevant to determining a likelihood of plagiarism for the first source code.

At step 1615 of the process 1600, the process may determine matching blocks of source code that exceed a predefined minimum length threshold based on the comparison. The predefined minimum length threshold may be a minimum threshold of the number of operators and reserved keywords. For instance, the predefined minimum length threshold may be fifteen, meaning that a subsequence of matching reserved keywords and operators below a length of fifteen may not be counted. Alternatively, a length of more than fifteen reserved keywords and operators may be counted toward potential errors. For instance, a length of more than fifteen reserved keywords and operators may be counted toward the potential likelihood of plagiarism.

At step 1620 of the process 1600, the process may compute a ratio of total matched source code lines to total lines in the first source code based on the determination. For example, if the determination of matching blocks produces a result where thirty percent of the blocks in the source code match or have equal subsequences to blocks in the historical source codes, the process 1600 may determine a ratio of three to ten. The ratio may be determined in various ways. For instance, the ratio may be based on the number of matching operators and keywords between source codes in various embodiments. The ratio may also be based on the total length of matching portions of the source code without reducing the source codes down to just operators and reserved keywords.

At step 1625 of the process 1600, the process 1600 may determine a plagiarism likelihood score based on the ratio. For example, the process may include various thresholds for plagiarism likelihood based on the ratio. In an example, a ratio of less than one to ten may indicate a low plagiarism likelihood. A ratio of between one to ten and one to five may indicate a moderate plagiarism likelihood. A ratio of between one to five and three to ten may indicate a high plagiarism likelihood. And a ratio of above three to ten may indicate an extremely high plagiarism likelihood.

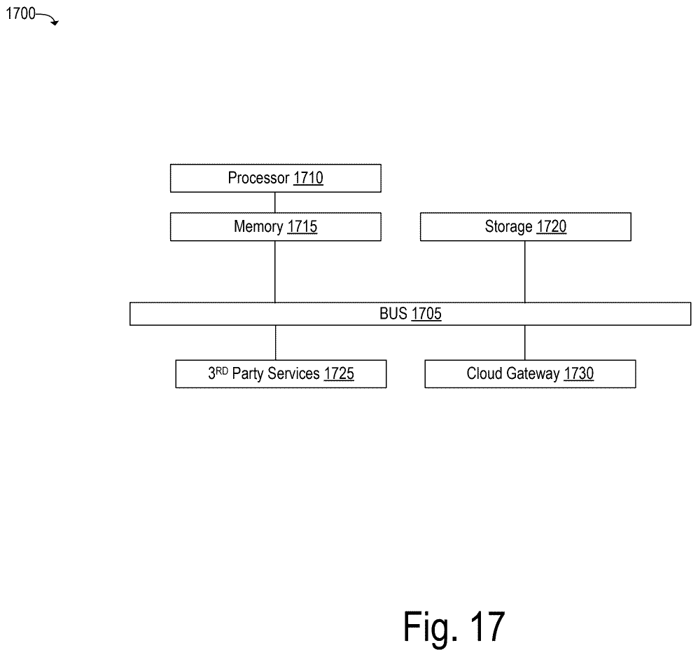

Referring to FIG. 17, FIG. 17 is a schematic illustrating a computing system 1700 that may be used to implement various features of embodiments described in the disclosed subject matter. The terms components, entities, modules, surface, and platform, when used herein, may refer to one of the many embodiments of a computing system 1700. The computing system 1700 may be a single computer, a co-located computing system, a cloud-based computing system, or the like. The computing system 1700 may be used to carry out the functions of one or more of the features, entities, and/or components of a software project.

The exemplary embodiment of the computing system 1700 shown in FIG. 17 includes a bus 1705 that connects the various components of the computing system 1700, one or more processors 1710 connected to a memory 1715, and at least one storage 1720. The processor 1710 is an electronic circuit that executes instructions that are passed to it from the memory 1715. Executed instructions are passed back from the processor 1710 to the memory 1715. The interaction between the processor 1710 and memory 1715 allow the computing system 1700 to perform computations, calculations, and various computing to run software applications.

Examples of the processor 1710 include central processing units (CPUs), graphics processing units (GPUs), field programmable gate arrays (FPGAs), complex programmable logic devices (CPLDs), and application specific integrated circuits (ASICs). The memory 1715 stores instructions that are to be passed to the processor 1710 and receives executed instructions from the processor 1710. The memory 1715 also passes and receives instructions from all other components of the computing system 1700 through the bus 1705. For example, a computer monitor may receive images from the memory 1715 for display. Examples of memory include random access memory (RAM) and read only memory (ROM). RAM has high speed memory retrieval and does not hold data after power is turned off. ROM is typically slower than RAM and does not lose data when power is turned off.

The storage 1720 is intended for long term data storage. Data in the software project such as computer readable specifications, code, designs, and the like may be saved in a storage 1720. The storage 1720 may be stored at any location including in the cloud. Various types of storage include spinning magnetic drives and solid-state storage drives.

The computing system 1700 may connect to other computing systems in the performance of a software project. For instance, the computing system 1700 may send and receive data from 3^{rd} party services such as Office 365 and Adobe. Similarly, users may access the computing system 1700 via a cloud gateway 1730. For instance, a user on a separate computing system may connect to the computing system 1700 to access data, interact with the run entities 108, and even use 3^{rd} party services 1725 via the cloud gateway.

A computer-implemented method for detecting plagiarism includes reading a first source code and generating a first fingerprint for the first source code, where the first fingerprint is a representation of the first source code that includes reserved keywords and operators. The method further includes comparing the first fingerprint with the fingerprints of historical source code submissions and generating a plagiarism likelihood score based on the comparison. The method may include generating the first fingerprint by tokenizing the first source code into a sequence of tokens based on a predefined set of reserved keywords and operators. The method may include comparing the first fingerprint with the fingerprints of historical source code submissions by identifying matching blocks in the first source code that exceed a predefined minimum length threshold. The method may further include computing a ratio of total matched source code lines to the total lines of relevant files in the first source code based on the identified matching blocks. The plagiarism likelihood score may be generated based on the computed ratio. The method may include reducing the first source code by removing comments and formatting before generating the first fingerprint. The predefined set of reserved keywords and operators may be stored in a configuration file specific to a programming language framework.

A computer system for detecting plagiarism includes a processor coupled to a memory. The processor is configured to execute software to read a first source code and generate a first fingerprint for the first source code, where the first fingerprint is a representation of the first source code that includes reserved keywords and operators. The system further includes comparing the first fingerprint with the fingerprints of historical source code submissions and generating a plagiarism likelihood score based on the comparison. The processor may be configured to generate the first fingerprint by tokenizing the first source code into a sequence of tokens based on a predefined set of reserved keywords and operators. The processor may be configured to compare the first fingerprint with the fingerprints of historical source code submissions by identifying matching blocks in the first source code that exceed a predefined minimum length threshold. The processor may be further configured to compute a ratio of total matched source code lines to the total lines of relevant files in the first source code based on the identified matching blocks. The processor may be configured to generate a plagiarism likelihood score based on the computed ratio. The processor may be further configured to reduce the first source code by removing comments and formatting before generating the first fingerprint. The predefined set of reserved keywords and operators may be stored in a configuration file specific to a programming language framework.

A computer-readable storage medium has data stored in it representing software executable by a computer. The software includes instructions that, when executed, cause the computer to read a first source code and generate a first fingerprint for the first source code, where the first fingerprint is a representation of the first source code that includes reserved keywords and operators. The software further includes comparing the first fingerprint with the fingerprints of historical source code submissions and generating a plagiarism likelihood score based on the comparison. The software may include generating the first fingerprint by tokenizing the first source code into a sequence of tokens based on a predefined set of reserved keywords and operators. The software may include comparing the first fingerprint with the fingerprints of historical source code submissions by identifying matching blocks in the first source code that exceed a predefined minimum length threshold. The software may further include computing a ratio of total matched source code lines to the total lines of relevant files in the first source code based on the identified matching blocks. The plagiarism likelihood score may be generated based on the computed ratio. The software may include reducing the first source code by removing comments and formatting before generating the first fingerprint.

A method for assessing a software developer includes assigning a developer a software coding test and receiving a source code from the developer in response to the software coding test. The method further includes analyzing the received source code based on one or more parameters of the software coding test, tokenizing the source code to generate a sequence of tokens where the tokenization is based on a predefined set of reserved keywords and operators specific to a programming language framework, and comparing the tokenized source code to one or more tokenized code sources. The method also includes determining a plagiarism score based on the comparison. The method may include the analysis being performed by an automated process. The predefined set of reserved keywords and operators may be stored in a configuration file specific to the programming language framework. The method may include analyzing the received source code by ranking the received source code based on the one or more parameters. The method may further include storing the tokenized source code in a database. The method may include identifying and excluding, based on the stored tokenized source code, tokens that are not relevant to the plagiarism score. The identifying may be performed using a machine learning model.

A computer system for generating a fingerprint includes a processor coupled to a memory. The processor is configured to execute software to assign a developer a software coding test, receive a source code, analyze the received source code based on one or more parameters of the software coding test, tokenize the source code to generate a sequence of tokens where the tokenization is based on a predefined set of reserved keywords and operators specific to a programming language framework, compare the tokenized source code to one or more tokenized code sources, and determine a plagiarism score based on the comparison. The analysis of the received source code may be performed by an automated process. The predefined set of reserved keywords and operators may be stored in a configuration file specific to the programming language framework. The processor may be configured to analyze the received source code by ranking the received source code based on the one or more parameters. The tokenized source code may be stored in a database. The processor may be further configured to identify and exclude, based on the stored tokenized source code, tokens that are not relevant to the plagiarism score. The processor may be configured to identify tokens using a machine learning model.

A computer-readable storage medium has data stored in it representing software executable by a computer. The software includes instructions that, when executed, cause the computer to assign a developer a software coding test, receive a source code from the developer in response to the software coding test, analyze the received source code based on one or more parameters of the software coding test, tokenize the source code to generate a sequence of tokens where the tokenization is based on a predefined set of reserved keywords and operators specific to a programming language framework, compare the tokenized source code to one or more tokenized code sources, and determine a plagiarism score based on the comparison. The software may include the analysis being performed by an automated process. The software may include analyzing the received source code by ranking the received source code based on the one or more parameters. The instructions may further cause the computer to store the tokenized source code in a database. The instructions may further cause the computer to identify and exclude, based on the stored tokenized source code, tokens that are not relevant to the plagiarism score. The identifying may be performed using a machine learning model.

A computer-implemented method for detecting plagiarism includes generating a fingerprint for a first source code and comparing the generated fingerprint of the first source code with fingerprints of historical source codes. The method further includes determining matching blocks of source code that exceed a predefined minimum length threshold based on the comparison, computing a ratio of total matched source code lines to total lines in the first source code based on the determination, and determining a plagiarism likelihood score based on the computation. The method may include determining the plagiarism likelihood score by applying a machine learning model trained on labeled examples of plagiarized and non-plagiarized code submissions. The method may include comparing the generated fingerprint of the first source code with fingerprints of historical source codes to identify the longest common subsequences between the fingerprints. The method may further include reducing the first source code by removing comments, whitespace, and formatting before generating the fingerprint. The method may include generating the fingerprint by tokenizing the source code to create a sequence of tokens. The tokenization may be based on a predefined set of reserved keywords and operators specific to a programming language framework. The method may include determining matching blocks of source code by identifying contiguous sequences of tokens in the fingerprints that match between the first source code and historical source codes.

A computer system for generating a fingerprint includes a processor coupled to a memory. The processor is configured to execute software to generate a fingerprint for a first source code, compare the generated fingerprint of the first source code with fingerprints of historical source codes, determine matching blocks of source code that exceed a predefined minimum length threshold based on the comparison, compute a ratio of total matched source code lines to the total lines in the first source code based on the determination, and determine a plagiarism likelihood score based on the computation. The processor may be configured to determine the plagiarism likelihood score by applying a machine learning model trained on labeled examples of plagiarized and non-plagiarized code submissions. The processor may be configured to compare the generated fingerprint of the first source code with fingerprints of historical source codes to identify the longest common subsequences between the fingerprints. The processor may be further configured to reduce the first source code by removing comments, whitespace, and formatting before generating the fingerprint. To generate the fingerprint, the processor may be configured to tokenize the source code to create a sequence of tokens. The processor may be configured to tokenize based on a predefined set of reserved keywords and operators specific to a programming language framework. The processor may be configured to determine the matching blocks of source code by identifying contiguous sequences of tokens in the fingerprints that match between the first source code and historical source codes.

A computer-readable storage medium has data stored in it representing software executable by a computer. The software includes instructions that, when executed, cause the computer to generate a fingerprint for a first source code, compare the generated fingerprint of the first source code with fingerprints of historical source codes, determine matching blocks of source code that exceed a predefined minimum length threshold based on the comparison, compute a ratio of total matched source code lines to the total lines in the first source code based on the determination, and determine a plagiarism likelihood score based on the computation. The software may include determining the plagiarism likelihood score by applying a machine learning model trained on labeled examples of plagiarized and non-plagiarized code submissions. The software may include comparing the generated fingerprint of the first source code with fingerprints of historical source codes to identify the longest common subsequences between the fingerprints. The software may further include reducing the first source code by removing comments, whitespace, and formatting before generating the fingerprint. The software may include generating the fingerprint by tokenizing the source code to create a sequence of tokens. The tokenization may be based on a predefined set of reserved keywords and operators specific to a programming language framework.

Many variations may be made to the embodiments of the software project described herein. All variations, including combinations of variations, are intended to be included within the scope of this disclosure. The description of the embodiments herein can be practiced in many ways. Any terminology used herein should not be construed as restricting the features or aspects of the disclosed subject matter. The scope should instead be construed in accordance with the appended claims.

1. A method for assessing a software developer, the method comprising:
assigning a developer a software coding test;
receiving a source code from the developer responsive to the software coding test;
analyzing the received source code based on one or more parameters of the software coding test;
tokenizing the source code to generate a sequence of tokens, wherein the tokenization is based on a predefined set of reserved keywords and operators specific to a programming language and a framework; and
comparing the tokenized source code to one or more tokenized code sources; and
determining a plagiarism score based on the comparing.

2. The method of claim 1, wherein the analyzing is performed by an automated process.

3. The method of claim 1, wherein the predefined set of reserved keywords and operators is stored in a configuration file specific to the programming language and the framework.

4. The method of claim 2, wherein analyzing the received source code includes ranking the received source code based on the one or more parameters.

5. The method of claim 1, further comprising storing the tokenized source code in a database.

6. The method of claim 5, further comprising identifying and excluding, based on the stored tokenized source code, tokens that are not relevant to the plagiarism score.

7. The method of claim 6, wherein the identifying is performed using a machine learning model.

8. A computer system to generate a fingerprint, the computer system comprising:
a processor coupled to a memory, the processor configured to execute a software to perform:
assign a developer a software coding test;
receive a source code;
analyze the received source code based on one or more parameters of the software coding test;
tokenize the source code to generate a sequence of tokens, wherein the tokenization is based on a predefined set of reserved keywords and operators specific to a programming language and a framework; and
compare the tokenized source code to one or more tokenized code sources; and
determine a plagiarism score based on the comparison.

9. The computer system of claim 8, wherein the analyze of the received source code is an automated process.

10. The computer system of claim 8, wherein the predefined set of reserved keywords and operators is stored in a configuration file specific to the programming language and the framework.

11. The computer system of claim 8, wherein to analyze the received source code, the processor is configured to rank the received source code based on the one or more parameters.

12. The computer system of claim 8, wherein the tokenized source code is stored in a database.

13. The computer system of claim 9, wherein the processor is further configured to identify and exclude, based on the stored tokenized source code, tokens that are not relevant to the plagiarism score.

14. The computer system of claim 8, wherein to identify tokens, the processor is configured to use a machine learning model.

15. A computer readable storage medium having data stored therein representing software executable by a computer, the software comprising instructions that, when executed, cause the computer readable storage medium to perform:
assigning a developer a software coding test;
receiving a source code from the developer responsive to the software coding test;
analyzing the received source code based on one or more parameters of the software coding test;
tokenizing the source code to generate a sequence of tokens, wherein the tokenization is based on a predefined set of reserved keywords and operators specific to a programming language and a framework; and
comparing the tokenized source code to one or more tokenized code sources; and
determining a plagiarism score based on the comparing.

16. The computer readable storage medium of claim 15, wherein the analyzing is performed by an automated process.

17. The computer readable storage medium of claim 15, wherein analyzing the received source code includes ranking the received source code based on the one or more parameters.

18. The computer readable storage medium of claim 17, wherein the instructions further cause the computer readable storage medium to perform storing the tokenized source code in a database.

19. The computer readable storage medium of claim 18, wherein the instructions further cause the computer readable storage medium to perform identifying and excluding, based on the stored tokenized source code, tokens that are not relevant to the plagiarism score.

20. The computer readable storage medium of claim 19, wherein the identifying is performed using a machine learning model.
